(19) United States
(12) Patent Application Publication
(10) Pub. No.: US 2025/0231721 A1
(43) Pub. Date: Jul. 17, 2025

(54) STORAGE MEDIUM, CONTROL METHOD, AND INFORMATION PROCESSING APPARATUS

(71) Applicant: CANON KABUSHIKI KAISHA, Tokyo (JP)

(72) Inventor: MASATO KOBAYASHI, Chiba (JP)

(21) Appl. No.: 19/020,549

(22) Filed: Jan. 14, 2025

(30) Foreign Application Priority Data
Jan. 17, 2024 (JP) 2024-005271

(51) Int. Cl. G06F 3/12

(52) U.S. Cl. CPC G06F 3/1205; G06F 3/1256; G06F 3/1274

(57) ABSTRACT

A computer-readable storage medium stores a program for supporting general-purpose printing software which is able to be used in common by image forming apparatuses of a plurality of manufacturers. When the program is executed, a processor causes an information processing apparatus to display a screen for receiving a setting of blank sheet saving, and perform control such that a page having no image data among data generated by the general-purpose printing software is not printed, based on the setting of blank sheet saving that has been received on the screen.

### BACKGROUND

### Field

The present disclosure relates to a storage medium, a control method, and an information processing apparatus.

### Description of the Related Art

There has been known a configuration of issuing a print instruction to a printing apparatus connected to a host computer, using a printer driver installed on the host computer serving as control software for the printing apparatus. An operating system (OS), which is basic software, is installed on the host computer. The printer driver is formed according to the specifications defined by the OS, and the printer driver operates by being invoked by the OS. By providing a printer driver compatible with the specification of the OS, a manufacturer that provides printing apparatuses can provide means for issuing a print instruction to a printing apparatus with the OS.

In recent years, Windows®, has been providing a standard class driver (hereinafter, referred to as a “standard driver”) that can be commonly used by printing apparatuses from a plurality of manufacturers. Such a standard driver is bundled in a package of the OS, and can easily be used by connecting an arbitrary printing apparatus to a host computer. Thus, there is no need to additionally install a printer driver unique to a model type that is suitable for a printing apparatus, which is highly convenient. The standard driver is also configured to be able to designate a print function in accordance with PrintDeviceCapabilities (hereinafter, “PDC”) generated based on information acquired from a connected printing apparatus. With this configuration, although a user uses one standard driver, the user can designate a print function suitable for the capability of the connected printing apparatus. Nevertheless, this is limited to functions that can be implemented only by the standard driver. Thus, a function unique to a printer manufacturer cannot be designated.

In view of the foregoing issue, Japanese Patent Application Laid-Open No. 2021-33526 discusses a technique of extending a function to implement an N-in-one printing function unique to a printer manufacturer with an extension application of the standard driver.

Here, there is a blank sheet saving function (blank sheet removal function) uniquely provided from a printer manufacturer. The blank sheet saving function is a function of executing printing while deleting a blank page on which nothing is drawn. This function allows the user to execute printing to skip a blank page without deleting the blank page by himself/herself.

Nevertheless, although the extension application discussed in Japanese Patent Application Laid-Open No. 2021-33526 can implement a toner saving processing in the printing executed using the standard driver, the extension application cannot implement the blank sheet saving function.

In a case where the user cannot use the blank sheet saving function, the user needs to delete a blank page by himself/herself before printing. This gives inconvenience to the user.

### SUMMARY

According to some embodiments, a computer-readable storage medium stores a program for supporting general-purpose printing software which is able to be used in common by image forming apparatuses of a plurality of manufacturers. When the program is executed, a processor causes an information processing apparatus to display a screen for receiving a setting of blank sheet saving, and perform control, based on the setting of blank sheet saving that has been received on the screen, such that a page having no image data among data generated by the general-purpose printing software is not printed.

Further features of the present disclosure will become apparent from the following description of exemplary embodiments with reference to the attached drawings.

### BRIEF DESCRIPTION OF THE DRAWINGS

FIG. 1 is a block diagram illustrating a hardware configuration of a printing system.

FIGS. 2A and 2B are software configuration diagrams of the printing system.

FIGS. 3A to 3F are diagrams each illustrating an example of a print setting screen to be displayed by a print setting extension unit.

FIG. 4 is a diagram illustrating a processing flow of edit processing of PrintDeviceCapabilities (PDC) to be executed by a print function extension unit.

FIG. 5 is a diagram illustrating an example of capability information to be acquired from a printing apparatus.

FIG. 6 is a diagram illustrating an example of functions and setting values supported by an extension application.

FIG. 7 is a diagram illustrating an example of a list of functions and options described in PDC generated by general-purpose printing software.

FIG. 8 is a sequence diagram between a drawing application, general-purpose printing software, an extension application, and a printing apparatus.

FIG. 9 illustrates a configuration of a printing system in a case where an extension application according to a second exemplary embodiment is associated.

FIG. 10 is a diagram illustrating a processing flow of edit processing of PDC that is to be executed by a print function extension unit according to the second exemplary embodiment.

FIG. 11 is a diagram illustrating an example of capability information to be acquired from a printing apparatus according to the second exemplary embodiment.

FIG. 12 is a sequence diagram between a drawing application, general-purpose printing software, an extension application, and a printing apparatus according to the second exemplary embodiment.

FIG. 13 is a diagram illustrating an example of blank pages and drawing commands according to an exemplary embodiment of the present invention.

FIG. 14 is a sequence diagram between a drawing application, general-purpose printing software, an extension application, and a printing apparatus according to a third exemplary embodiment.

FIG. 15 is a sequence diagram between a drawing application, general-purpose printing software, an extension application, and a printing apparatus according to a fourth exemplary embodiment.

FIGS. 16A to 16C are diagrams each illustrating an example of a print setting and a preview screen to be displayed by a print setting extension unit according to the fourth exemplary embodiment.

FIG. 17 is a block diagram illustrating an example of a part of processing of print data transmitted by a printing apparatus.

FIG. 18 is a flowchart illustrating a basic processing example of a blank sheet saving function according to a first exemplary embodiment.

FIG. 19 is a flowchart illustrating a processing example of a blank sheet saving function mode 2 according to the third exemplary embodiment.

FIG. 20 is a block diagram illustrating a hardware configuration of a printing apparatus according to an exemplary embodiment.

### DESCRIPTION OF THE EMBODIMENTS

Hereinafter, various exemplary embodiments, features, and aspects of the present disclosure will be described in detail with reference to the accompanying drawings. The following exemplary embodiments are not intended to limit the present disclosure set forth in the appended claims. In addition, not all the combinations of features described in the present exemplary embodiment are always essential to the solution of the present disclosure.

The same components are assigned the same reference numerals, and the description will be omitted.

### <Hardware Configuration of Printing System>

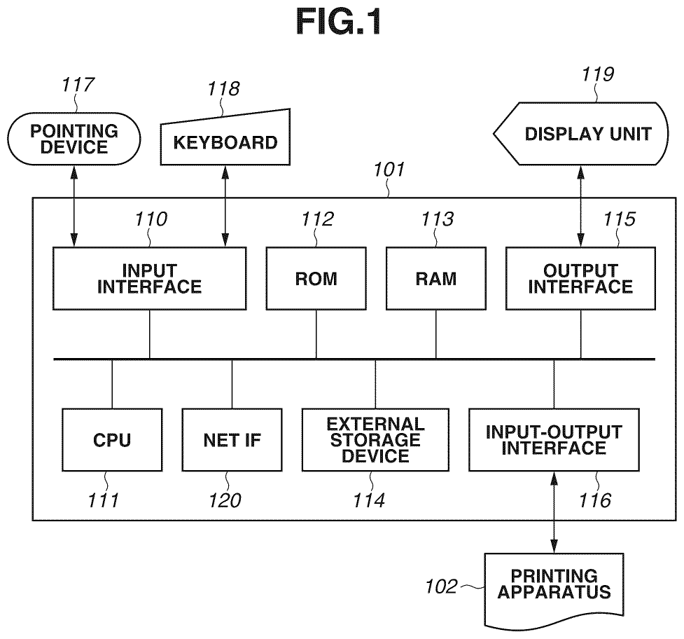

FIG. 1 is a block diagram illustrating a hardware configuration of a printing system. In FIG. 1, a host computer 101 is an example of an information processing apparatus, and includes an input interface 110, a central processing unit (CPU) 111, a read-only memory (ROM) 112, a random access memory (RAM) 113, an external storage device 114, an output interface 115, and an input-output interface 116. In addition, input devices, such as a keyboard 118 and a pointing device 117, are connected to the input interface 110, and a display device, such as a display unit 119, is connected to the output interface 115. A network interface (NET IF) 120 is a network interface, and performs control for transferring data with an external device via a network.

The ROM 112 stores an initialization program. The external storage device 114 stores application programs, an operating system (OS), print data generation software, and other various types of data. The RAM 113 is used as a work memory when various programs stored in the external storage device 114 are executed, and the various programs are operable in the host computer 101.

In the first exemplary embodiment, the CPU 111 executes a function of the host computer 101 and processing according to a flowchart that are to be described below, by performing processing in accordance with a procedure of a program stored in the ROM 112. A printing apparatus 102 serving as a device is an example of an image forming apparatus, and is connected with the host computer 101 via the input-output interface 116.

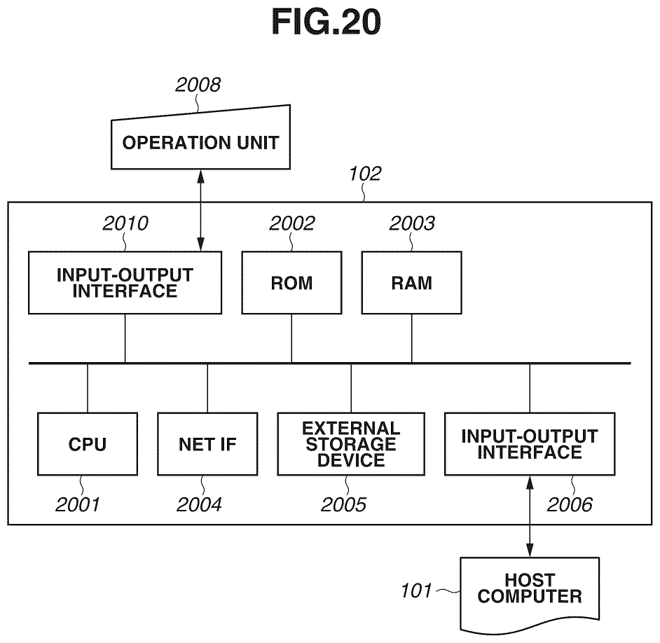

The configuration of the printing apparatus 102 will be described with reference to FIG. 20.

A CPU 2001 comprehensively controls the printing apparatus 102.

A ROM 2002 is a storage medium that stores a program to be read by the CPU 2001.

A RAM 2003 functions as a work memory of the CPU 2001, and stores a program read out from the ROM 2002.

A NET IF 2004 is a network interface, and performs control of transferring data with an external device via a network.

An external storage device 2005 is a large-capacity storage medium that stores image data.

The printing apparatus 102 is connected with the host computer 101 via an input-output interface 2006. The host computer 101 and the printing apparatus 102 may be connected with the NET IF 120 and the NET IF 2004, and may communicate with each other via the NET IF 120 and the NET IF 2004.

The printing apparatus 102 is connected with an operation unit 2008 via an input-output interface 2010. The operation unit 2008 includes a touch panel functioning as a display unit, and hardware keys. The operation unit 2008 displays a setting screen and the state of the printing apparatus 102 via the touch panel. The operation unit 2008 also receives operations from the user via the touch panel or the hardware key.

In this example, the host computer 101 and the printing apparatus 102 are separately formed, but these may be formed as one information processing apparatus. A print setting screen and an advanced settings screen, which will be described below, are displayed on the display unit 119. In the present exemplary embodiment, an electrophotographic digital multifunction peripheral having a plurality of functions such as copy, print, and facsimile (FAX) functions will be described as an example of a printing apparatus. Nevertheless, the printing apparatus is not limited to this. For example, the present exemplary embodiment can also be applied to a device that uses another process, such as an inkjet method. The host computer 101 may also be a desk-top personal computer, a smartphone, a laptop personal computer, or other device.

<Configuration of Printing System that is Centered on Software>

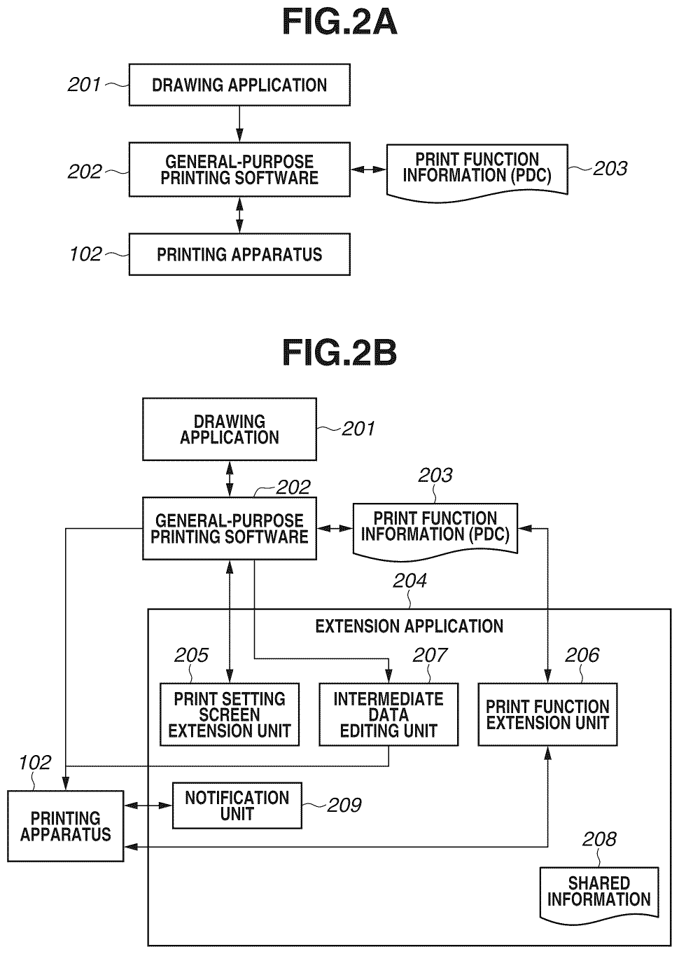

FIGS. 2A and 2B are diagrams schematically illustrating a software configuration of a printing system. Here, the description will be given based on a printing system that uses the host computer 101 on which Windows® 11 of Microsoft® is installed as an OS. FIG. 2A is a diagram illustrating a general configuration in a case where an extension application 204 is not associated with a general-purpose printing software 202 and the printing apparatus 102. FIG. 2B is a diagram illustrating a configuration in a case where the extension application 204 is associated with the general-purpose printing software 202 and the printing apparatus 102.

<Configuration of Printing System Centered on Software Configuration of Printing System that is Centered on Software (in Case where Extension Application is not Associated)>

First of all, a configuration of a printing system in a case where the extension application 204 is not associated will be described with reference to FIG. 2A.

A drawing application 201 is software that creates content (drawing data) to be printed. For example, the drawing application 201 corresponds to a document creation application or a table calculation application. When the drawing application 201 receives a print request from the user, the drawing application 201 issues a print instruction to an OS. The print instruction includes print setting information for issuing an operation instruction of the general-purpose printing software 202 and the printing apparatus 102. The print setting information will also be referred to as a PrintTicket (hereinafter, “PT”).

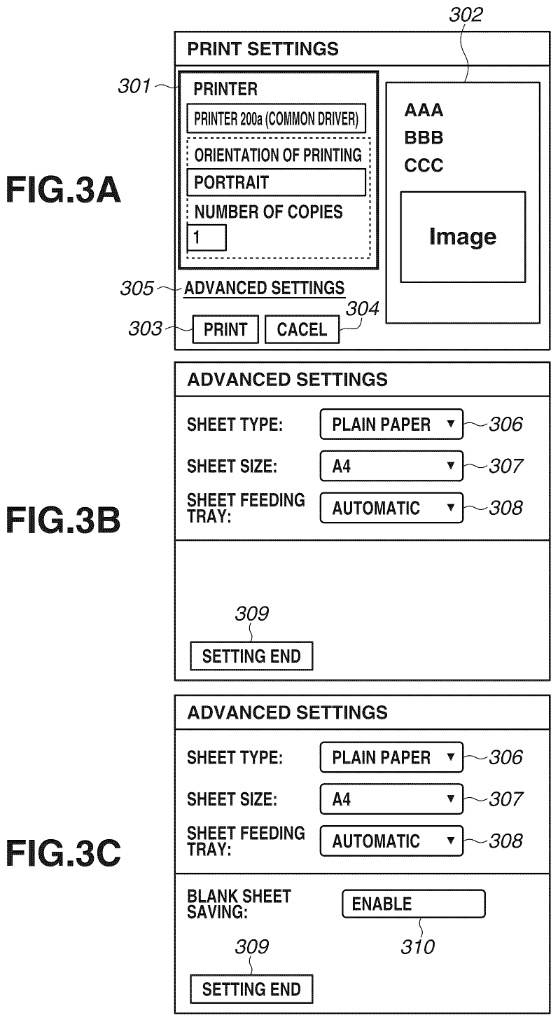

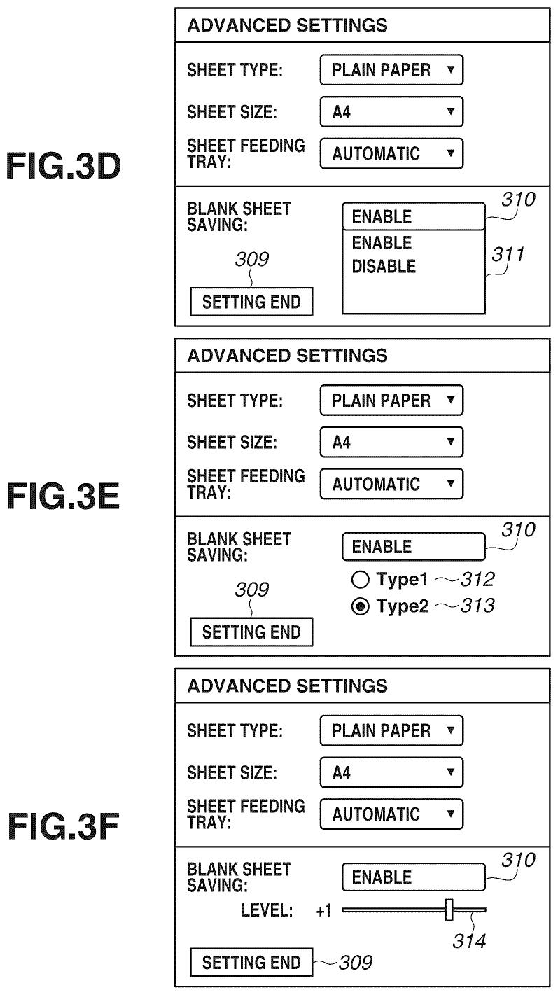

In order to output the PT, the drawing application 201 can display a print setting screen provided by any of the general-purpose printing software 202, OS, or the drawing application 201. If an advanced settings button in the print setting screen is pressed, the general-purpose printing software 202 additionally display the advanced settings screen. The print setting screen and the advanced settings screen will be described below with reference to FIGS. 3A to 3F. The advanced settings screen includes capability information (settable information) of the general-purpose printing software 202, a setting item (hereinafter, also referred to as a “control item”) indicating a settable print function, and a control item indicating its setting value. The capability information will also be referred to as PrintCapabilities (hereinafter, “PC”). The general-purpose printing software 202 determines PC based on print function information 203. The print function information 203 is data indicating print functions, in which all settable print functions and their setting values, and an exclusive relationship between setting values are described. The print function information 203 will also be referred to as Print Device Capabilities (PDC). The PDC 203 is included in a configuration file of the general-purpose printing software 202, and is arranged in the external storage device 114 as an unmodifiable file. Alternatively, the PDC 203 can also be dynamically generated by the general-purpose printing software 202. Specifically, the general-purpose printing software 202 or the OS can be configured to acquire attribute data of the printing apparatus from the printing apparatus 102, and generate the PDC 203 in accordance with attribute information in the acquired attribute data. In a case where the PDC 203 is dynamically generated, the generated PDC 203 is editable. The attribute data of the printing apparatus that is to be acquired from the printing apparatus 102 is a response to be acquired by issuing a Get-Printer-Attributes operation of an Internet printing protocol (IPP) to the printing apparatus. The response includes attribute information indicating a function that can be designated by the printing apparatus 102 (capability of the printing apparatus), and a setting value related to the attribute information. This response is stored in the RAM 113.

With this configuration, the general-purpose printing software 202 enables the user to designate a print function that can be used in each printing apparatus 102, in accordance with the connected printing apparatus 102. In other words, the general-purpose printing software 202 enables the user to designate an available print function in accordance with a connected printing apparatus, even in a case where printing apparatuses having different functions or printing apparatuses developed by different manufacturers (or venders) are connected. Here, a configuration that uses an IPP Class Driver, which is installed on Windows® 11 as the general-purpose printing software 202, will be described. The IPP Class Driver is a printer driver that executes print processing in accordance with the specification of a standard print protocol called an internet printing protocol (IPP), and is pre-installed in the package of the OS. The IPP Class Driver is not a unique printer driver suitable for the model type of the printing apparatus 102, but is a standard class driver that can be used in common by a plurality of printing apparatuses. In addition, the IPP Class Driver acquires capability information of the connected printing apparatus 102, and generates the PDC 203 based on the acquired capability information in such a manner that the user can designate a print function supported by the connected printing apparatus 102. Nevertheless, the IPP Class Driver does not support a blank sheet saving function (blank sheet removal function). This is because the blank sheet saving function is a function unique to a printer manufacturer. Here, the blank sheet saving function and a use case of the blank sheet saving function will be described.

### <Blank Sheet Saving Function>

As described above, the blank sheet saving function is a function of executing printing while deleting a blank page on which nothing is drawn, in such a manner that the blank page of print data is not to be printed. In a document including a plurality of pages created by document creation software, a blank page on which no sentence nor image is drawn sometimes exists. When such a document is printed, there is a case where the user desires to print the document while deleting the blank page for the reason of paper saving. In such a case, the blank sheet saving function can execute printing in a state in which the blank page is deleted, without manually deleting the blank page.

### <Use Case of Blank Sheet Saving Function>

Data of a document to be printed includes an unintended blank page in some cases. Examples of such cases include a case where software that has created the document and printing software are different, a case where versions of these pieces of software are different, a case where a format of the document has changed, and a case where not document data created by the user but received document data includes a blank page. Aside from these, there are various cases where an unintended blank page is included in document data. If blank pages are several pages, it is not so bothersome to delete the blank pages and execute printing. Nevertheless, in a case where many blank pages such as several tens of blank pages are included, it is very bothersome to manually delete these blank pages. In such a case, a blank sheet saving function can automatically delete the blank pages, and easily print pages other than the blank pages.

The description will return to FIG. 2A. If a print instruction is issued from the drawing application 201, a module of the OS in the general-purpose printing software 202 generates intermediate data (also referred to as input data). The data to be output for printing by the drawing application 201 is data in a Graphic Device Interface format (GDI-format data) or data in an Extensible Markup Language (XML) Paper Specification format (XPS-format data). In a case where the IPP Class Driver is used as the general-purpose printing software 202, the general-purpose printing software 202 performs conversion as follows. If data output by the drawing application 201 is GDI-format data, the OS converts the GDI-format data output from the drawing application 201, into XPS-format data. The intermediate data includes drawing data, which is information regarding a picture to be formed on a paper surface, and a PT set by the user.

The general-purpose printing software 202 converts the acquired intermediate data into print data interpretable by the printing apparatus 102, and transmits the converted print data to the printing apparatus 102. Here, print data in the present exemplary embodiment is page description language (PDL) data complying with the IPP. The PDL data complying with the IPP is, for example, portable document format (PDF) data or Printer Working Group (PWG)-Raster format data. The print data includes print setting attribute information (attribute information designating a print setting) generated based on the drawing data, which is information regarding a picture to be formed on a paper surface, and the PT set by the user. The print setting attribute information includes attribute information indicating a function that can be designated by the printing apparatus 102 (capability of the printing apparatus), and setting values related to the attribute information.

The printing apparatus 102 performs printing onto a paper surface based on print data transmitted from the general-purpose printing software 202. At this time, the printing apparatus 102 forms drawing data included in the print data, onto a paper surface (sheet surface) by an operation following the print setting attribute information included in the print data. The print setting attribute information includes printing quality (e.g., image quality priority, and speed priority), attribute information for designating duplex printing, and a setting value thereof. For example, in a case where the print setting attribute information includes the attribute information for designating duplex printing and a setting value indicating that the duplex printing is to be executed, the printing apparatus 102 executes duplex printing duplex printing.

<Configuration of Printing System Centered on Software (in Case where Extension Application is Associated)>

Next, the configuration of the printing system in a case where the extension application 204 is associated will be described with reference to FIG. 2B. The configuration and the processing that will not be specifically mentioned below are configurations similar to those in FIG. 2A.

The drawing application 201, the general-purpose printing software 202, and the extension application 204 each illustrated in FIG. 2B are stored in the external storage device 114 in FIG. 1. The CPU 111 loads these items from the external storage device 114 into the RAM 113 and executes them, thereby performing processing illustrated in the flowcharts and sequence diagrams to be described below.

The extension application 204 is software for extending the function of the general-purpose printing software 202, and is software not preliminarily included (not bundled) in the OS. Thus, the user operates the host computer 101, downloads the extension application 204 from a server via the internet, and installs the extension application 204.

Alternatively, the extension application 204 may be automatically installed based on the printing apparatus 102 being connected to the host computer 101. Specifically, the OS acquires device identification information from the printing apparatus 102 in a case where the printing apparatus 102 is connected to the host computer 101. The OS may download the extension application 204 corresponding to the acquired device identification information from a server via the internet, and install the extension application 204. That is, the general-purpose printing software 202 and the extension application 204 are held in the host computer 101 as different files.

In some cases, the general-purpose printing software 202 and the extension application 204 are updated and upgraded, and the update processing is performed at different timings. That is, a timing at which the general-purpose printing software 202 is acquired by the host computer 101, and a timing at which the extension application 204 is acquired are different. In addition, a trigger based on which the general-purpose printing software 202 is acquired by the host computer 101, and a trigger based on which the extension application 204 is acquired are also different. In a case where the extension application 204 is installed, the OS associates the extension application 204 with the general-purpose printing software 202 and the printing apparatus 102.

The extension application 204 to be described in the present exemplary embodiment includes a print setting screen extension unit 205, a print function extension unit 206, an intermediate data editing unit 207, and a notification unit 209. The extension application 204 includes shared information 208 accessible in common from each unit. The shared information 208 itself is a file stored in the external storage device 114 or information stored in the RAM 113. By using an application program interface (API) provided by the OS, the extension application 204 writes information into and reads out information from the shared information 208.

The extension application 204 may end an operation each time processing of each unit ends. In this case, the OS activates the extension application 204 each time a request for use of each unit is received.

Furthermore, the extension application 204 may cancel processing of each unit during the processing. When the processing is cancelled, an ongoing job on a print queue is deleted by the OS.

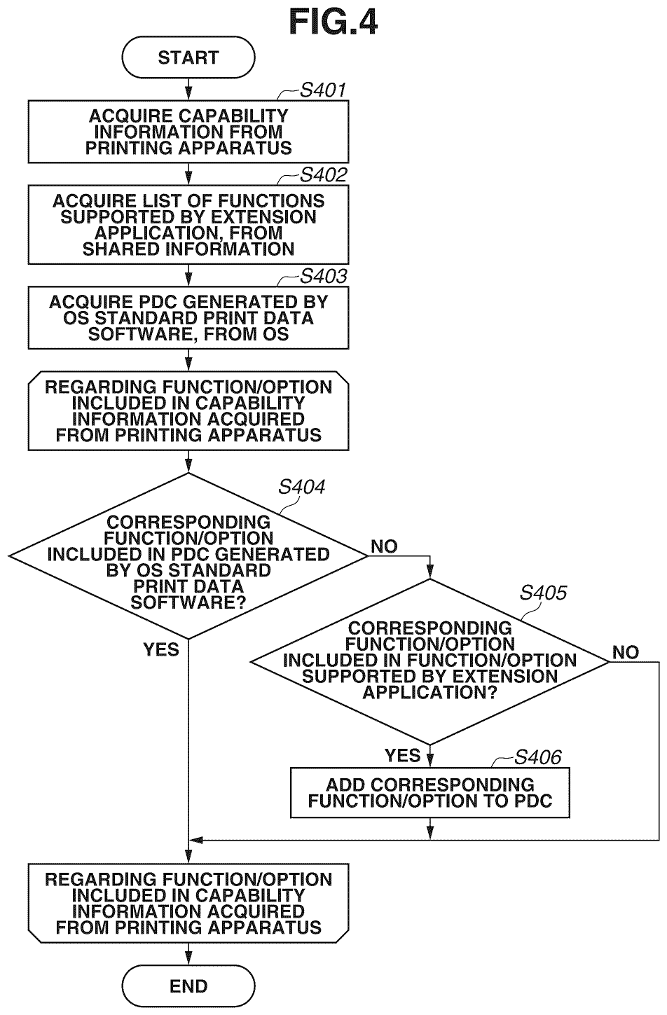

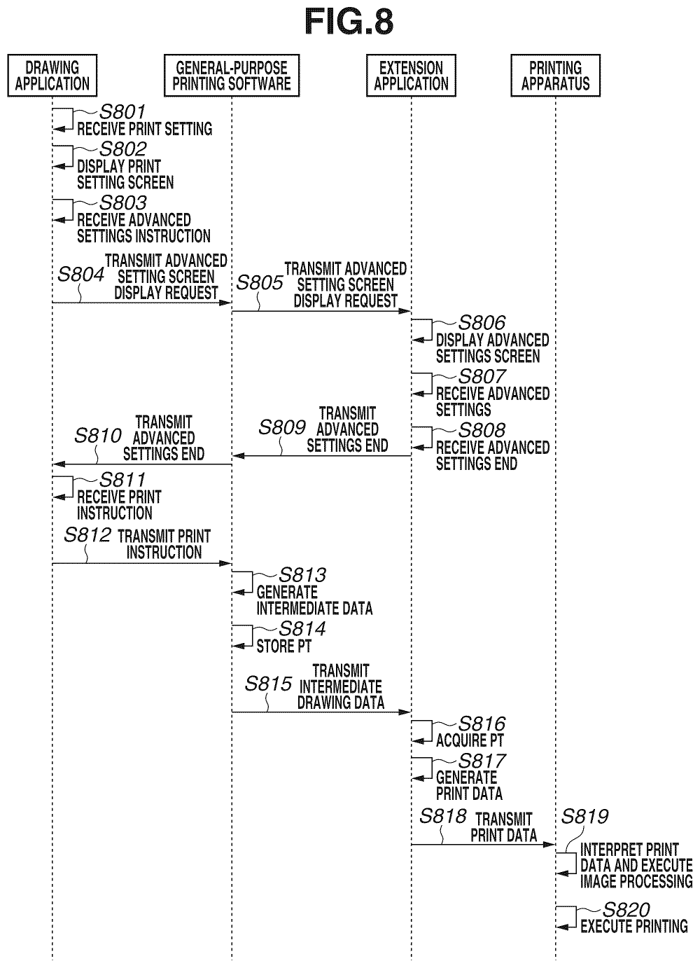

When the drawing application 201 receives a print request from the user, the drawing application 201 issues a print instruction to the OS. Even under this configuration, the drawing application 201 can display the print setting screen similarly to the configuration illustrated in FIG. 2A. Under this configuration, the advanced settings screen provided by the extension application 204 is displayed. Specifically, the advanced settings screen provided by a print setting screen extension unit 205 included in the extension application 204 is displayed. The print setting screen extension unit 205 can store advanced settings set by the user, into the shared information 208. The details of the print setting screen extension unit 205 will be described below with reference to FIGS. 4 and 8.

The extension application 204 includes the intermediate data editing unit 207. The intermediate data editing unit 207 acquires intermediate data from the general-purpose printing software 202, converts the intermediate data into print data, and delivers the print data to the printing apparatus 102. The intermediate data editing unit 207 also acquires advanced settings information from the shared information 208, and adds the advanced settings to the print data.

Based on the received print data, the printing apparatus 102 performs printing onto a paper surface. The method of converting intermediate data into print data is not limited to the above-described method. The extension application 204 may be configured to acquire print data generated by the general-purpose printing software 202, and add advanced settings to the print data. Even in the configuration illustrated in FIG. 2B, a setting of the blank sheet saving function or the like that is displayed by the extension application 204 is sometimes not made by the user.

In this case, as in the configuration illustrated in FIG. 2A, the general-purpose printing software 202 may deliver print data to the printing apparatus 102 without going through the extension application 204.

The extension application 204 includes the print function extension unit 206.

The print function extension unit 206 can edit the PDC 203 generated by the general-purpose printing software 202 or the OS. The print function extension unit 206 can thereby add a function provided by the extension application 204, and a function (e.g., blank sheet saving function) supported by the printing apparatus 102 but unsupported by the general-purpose printing software 202.

The print function extension unit 206 can also add an exclusive relationship between setting values of a print function. The OS activates the print function extension unit 206 when the extension application 204 is first associated with the printing apparatus 102 and the general-purpose printing software 202. The OS may also activate the print function extension unit 206 at other timings such as at the time of activation of the OS. With this configuration, the print function extension unit 206 can detect an extended function and add the extended function to the PDC 203, in a case where an optional device (e.g., finisher) is added to the printing apparatus 102 afterward and a function related to printing is extended.

The extension application 204 also includes the notification unit 209. The notification unit 209 can display a notification to the user in response to error occurrence in the printing apparatus 102. For example, when a paper empty error occurs in the printing apparatus 102, the general-purpose printing software 202 detects the paper empty error, and the OS displays a message on the display unit 119 using a notification function called a toast notification, which is a function of the OS. By the user pressing this toast notification, the notification unit 209 of the extension application 204 is invoked by the OS, and a user interface (UI) screen of the notification unit 209 is displayed. On the UI screen of the notification unit 209, for example, a detailed message of the paper empty error or a sheet replenishing method can be displayed.

If the extension application 204 once transmits print data to the printing apparatus 102, the extension application 204 cannot display a screen of a guide associated with print data, during the processing of each unit.

The configuration of the extension application 204 for implementing the present exemplary embodiment is not limited to the configuration including all the above-described functions (units), and may be a configuration including only a part of the functions, or a configuration including another function. The extension application 204 will sometimes simply be referred to as printing software. As described above, it can be said that the extension application 204 includes at least one of functions to be described next. The first function is a function of displaying a setting screen (the print setting screen extension unit 205). The second function is a function of editing and converting intermediate data into print data, and adding the advanced settings to the print data (the intermediate data editing unit 207). The third function is a function of extending a function that can be designated by print data generation software (the print function extension unit 206). The fourth function is a function of displaying a screen in response to error occurrence in the printing apparatus 102 (the notification unit 209).

### Processing Example of Blank Sheet Saving Function

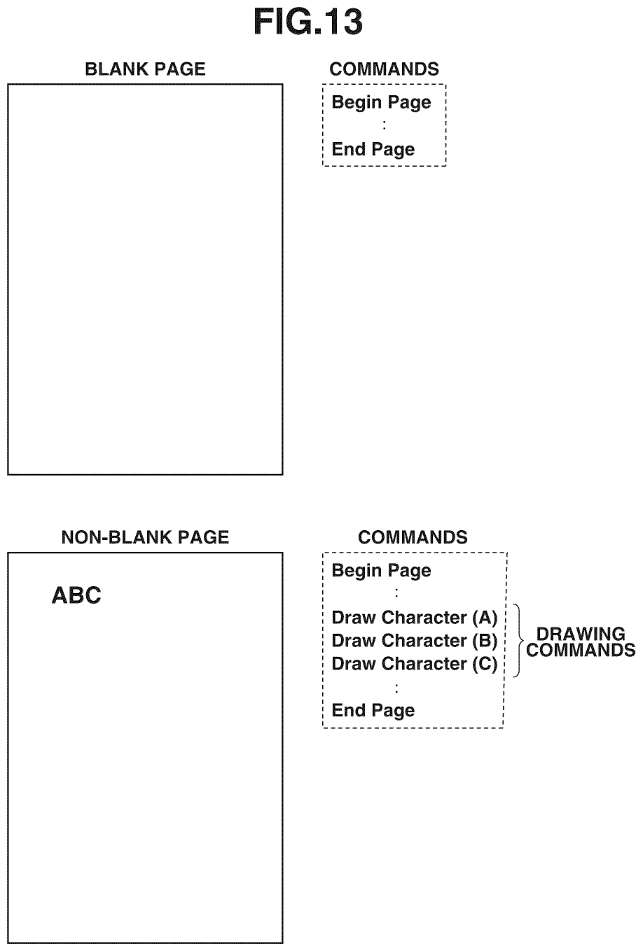

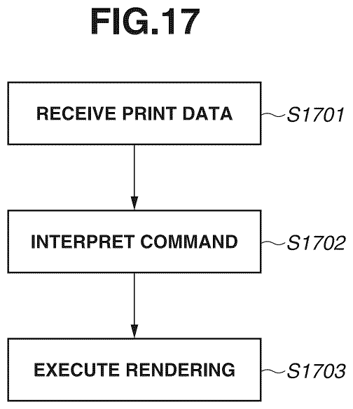

Here, a basic processing example of the blank sheet saving function will be described. In the present exemplary embodiment, a blank page refers to a page for which print data includes no drawing command. FIG. 13 illustrates examples of drawing commands of a blank page and a non-blank page. In FIG. 13, “Draw Character( )” indicates a command example for drawing a character. Aside from this, there are various drawing commands for drawing lines, figures, and images. A page for which print data does not include any of these commands is determined to be a blank page, and a page for which print data includes one or more commands is determined to be not a blank page. FIG. 17 illustrates a part of processing regarding print data that is to be executed after the print data is transmitted to the printing apparatus 102. In step S1701, the CPU 2001 of the printing apparatus 102 receives print data. In step S1702, the CPU 2001 interprets a command, and in step S1703, the CPU 2001 executes rendering in accordance with a drawing command in the command. The rendering in the present exemplary embodiment refers to processing of generating a bitmap image in accordance with a drawing command of print data. An image to be generated after rendering is not limited to bitmap images, and may be an image in any format as long as print data is converted in accordance with a drawing command into an image format manageable by the printing apparatus 102. In the present exemplary embodiment, in a case where the blank sheet saving function is enabled, whether a drawing command is included is determined when a command is interpreted. In a case where no drawing command is included, a corresponding page is determined to be a blank page and deleted.

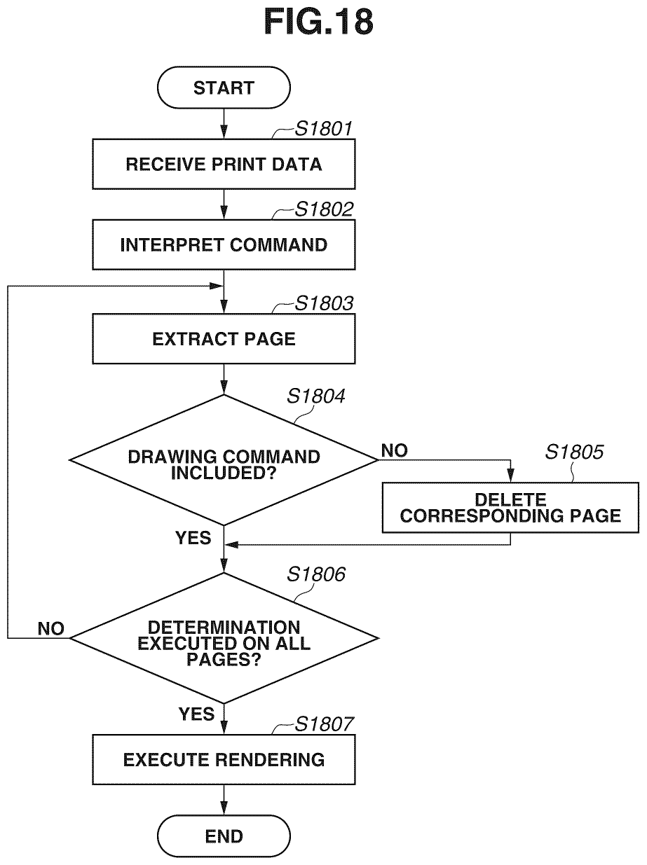

FIG. 18 illustrates a flow of processing to be performed by the printing apparatus 102 from print data reception to rendering in a case where the blank sheet saving function is enabled. The processing illustrated in FIG. 18 is performed by the printing apparatus 102. In the present exemplary embodiment, the processing is implemented by the CPU 2001 of the printing apparatus 102 in FIG. 20 loading a program stored in the ROM 2002, into the RAM 2003 and executing the program.

First of all, in step S1801, the CPU 2001 of the printing apparatus 102 receives print data.

In step S1802, the CPU 2001 interprets a command. As illustrated in FIG. 13, the CPU 2001 extracts each command included in print data, from the print data.

In step S1803, the CPU 2001 extracts a command corresponding to one page, from the command extracted in step S1802. In the present exemplary embodiment, a command sandwiched between Begin Page and End Page as illustrated in FIG. 13 is a command corresponding to one page, and thus the CPU 2001 extracts a command of a corresponding part.

In step S1804, the CPU 2001 determines whether a drawing command is included in the command extracted in step S1803. Whether a drawing command is included is determined by comparing the command with drawing commands prestored in a storage medium of the ROM 2002 of the printing apparatus 102, and determining whether there is an identical command. If there is no identical command, the CPU 2001 determines that a drawing command is not included.

In a case where it is determined in step S1804 that a drawing command is not included (NO in step S1804), the processing proceeds to step S1805. In step S1805, the CPU 2001 deletes a corresponding page. The deletion of the corresponding page is performed by deleting all commands corresponding to the page that have been extracted in step S1803. For example, information indicating a data size corresponding to a total number of pages is corrected by decrementing a value.

After step S1805, or in a case where it is determined in step S1804 that a drawing command is included (YES in step S1804), the processing proceeds to step S1806. In step S1806, the CPU 2001 determines whether drawing command determination has been executed on all pages. Whether drawing command determination has been executed on all pages may be determined based on the total number of pages of print data by the CPU 2001 determining whether the total number of pages becomes 0 after decrementing the value of the total number of pages by 1 each time the processing in step S1804 is executed. Alternatively, whether drawing command determination has been executed on all pages may be determined by storing the number of times the processing in step S1804 is executed, and determining whether the number of times becomes equal to the value of the total number of pages. In a case where the CPU 2001 determines in step S1806 that determination on all pages has not been executed (NO in step S1806), the processing returns to step S1803.

In a case where it is determined in step S1806 that determination on all pages has been executed (YES in step S1806), the processing proceeds to step S1807. In step S1807, the CPU 2001 performs rendering processing.

### Example of Print Setting Screen/Advanced Settings Screen

Next, an example of the print setting screen and the advanced settings screen according to the present exemplary embodiment will be described with reference to FIGS. 3A to 3F. FIG. 3A illustrates the print setting screen to be displayed by the drawing application 201. FIG. 3B illustrates the advanced settings screen to be displayed in the case of the configuration in which the extension application 204 is not installed as illustrated in FIG. 2A. FIG. 3C illustrates the advanced settings screen to be displayed in the case of the configuration in which the extension application 204 is installed as illustrated in FIG. 2B. The unit and the module that display the print setting screen are not limited to the above-described unit. For example, the print setting screen extension unit 205 may be configured to only generate a display screen. In such a case, the print setting screen extension unit 205 transmits the generated display screen to the drawing application 201 via the general-purpose printing software 202. The drawing application 201 may be configured to display the acquired display screen.

### <FIG. 3A: Print Setting Screen to be Displayed by Drawing Application>

Firstly, the description will be given with reference to FIG. 3A. A control 301 can make the user to set a printer to be used in printing, the orientation of printing, and the number of copies. A control 302 is a preview screen, a control 303 is a printing start button, and a control 304 is a button for cancelling printing. A control 305 is an advanced settings button. When the control 305 is pressed, an additional printing screen is displayed by the general-purpose printing software 202 or the print setting screen extension unit 205.

### <FIG. 3B: Advanced Settings Screen to be Displayed by General-Purpose Printing Software>

Next, the description will be given with reference to FIG. 3B. FIG. 3B illustrates an additional setting screen to be displayed by the general-purpose printing software 202 in a case where the extension application 204 is not installed. A control 306 can set a sheet type, and indicates that plain paper is selected. In a similar manner, a control 307 can designate a sheet size, and a control 308 can designate a sheet feeding tray of the printer. A control 309 is a setting end button. When the control 309 is pressed, the screen returns to the print setting screen illustrated in FIG. 3A.

### <FIGS. 3C and 3D: Print Setting Screen to be Displayed by Print Setting Screen Extension Unit>

Next, the description will be given with reference to FIGS. 3C and 3D. FIG. 3C illustrates an additional setting screen to be displayed by the print setting screen extension unit 205 in a case where the extension application 204 is installed. Unlike FIG. 3B, a control 310 is added. The control 310 is an object (e.g., pull-down menu) that makes the setting of the blank sheet saving function selectable. FIG. 3C illustrates that “enable” the blank sheet saving is selected, as an example. FIG. 3D illustrates a setting item list 311 to be displayed when the control 310 of blank sheet saving is pressed, as an example. The setting item list 311 indicates that “disable” is selectable aside from currently selected “enable”. By selecting enabling/disabling blank sheet saving from among the setting item list 311, the user can perform printing while switching the execution of blank sheet saving.

As illustrated in FIG. 3E, the type of blank sheet saving processing may be made switchable when “enable” blank sheet saving is selected. For example, when “enable” blank sheet saving is selected, a type is made selectable by displaying buttons 312 and 313. In FIG. 3E, a type 2 (button 313) is selected as an example. In the present exemplary embodiment, when a type 1 (button 312) is selected, for example, a blank page is deleted only in simplex printing, and a blank page is not deleted in duplex printing. When the type 2 (button 313) is selected, the deletion of blank pages is made selectable irrespective of simplex/duplex printing. Alternatively, by displaying “enable (Type1)”, “enable (Type2)”, or “disable” in the setting item list 311, a processing type and enable/disable may be concurrently selectable. As a matter of course, processing to be switched for each type is not limited to this, and the number of selectable types is not limited to two, and may be three or more.

Here, the reason why print setting items vary among FIGS. 3B, 3C, and 3D will be described. The advanced settings screen is generated with reference to PC generated based on print function information.

Nevertheless, the general-purpose printing software 202 does not support the blank sheet saving function, and therefore the blank sheet saving function cannot be added to print function information. Even if print function information originally includes the blank sheet saving function, the general-purpose printing software 202 cannot interpret the blank sheet saving function included in the print function information, and thus the general-purpose printing software 202 cannot display a blank sheet saving setting on the advanced settings screen. Nevertheless, the print function extension unit 206 is configured to add the blank sheet saving function to the PDC 203, and the print setting screen extension unit 205 is configured to display the advanced settings screen with reference to PC. With these configurations, the extension application 204 can display the blank sheet saving setting on the advanced settings screen. Here, an example in which only the blank sheet saving setting is added and made settable has been described, but an N-in-one layout function of printing a plurality of pages on one sheet. However, a color adjustment function of adjusting the color of an image may also be additionally made settable.

### <Flowchart of Print Function Extension Unit That Edits PDC>

Here, a processing flow in which the print function extension unit 206 edits the PDC 203 will be described with reference to FIG. 4. The processing in each step of FIG. 4 is implemented by the CPU 111 executing the print function extension unit 206 of the extension application 204.

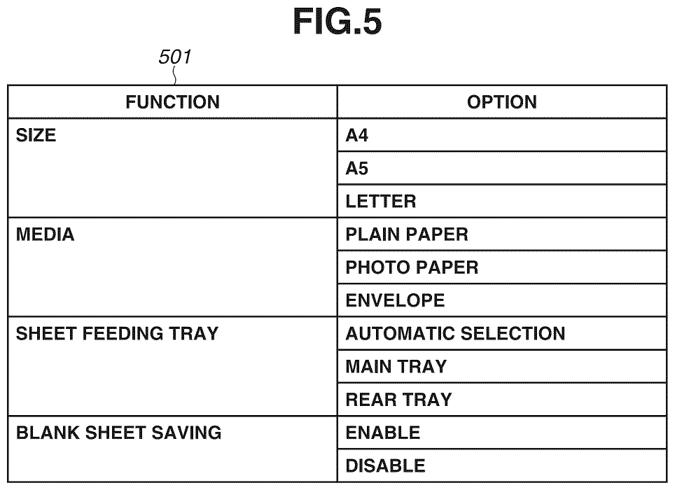

Firstly, in step S401, the CPU 111 executes the print function extension unit 206, and acquires capability information from the printing apparatus 102. The capability information includes attribute information indicating a function that can be designated by the printing apparatus 102, and a setting value related to the attribute information, which are included in a response to be acquired by issuing a Get-Printer-Attributes operation of the IPP to the printing apparatus 102. A table 501 illustrated in FIG. 5 indicates an example of a list of capability information acquired from the printing apparatus 102. As indicated in the table 501, a function such as the blank sheet saving function, and an option settable for each function can be acquired from the printing apparatus 102.

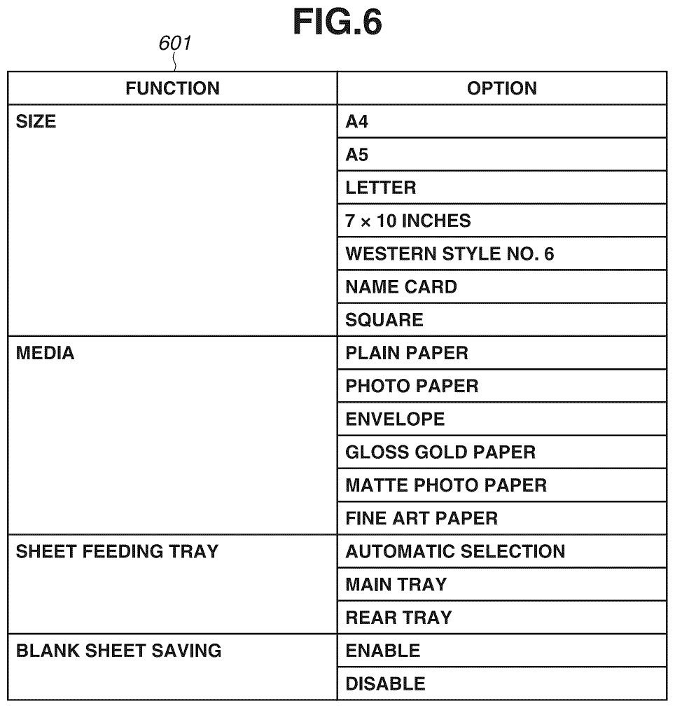

In step S402, the CPU 111 executes the print function extension unit 206, and acquires a list of print functions supported by the extension application 204, from the shared information 208. The list of print functions supported by the extension application 204 is stored in the shared information 208, and all print functions processable by the extension application 204 and their setting values are described in the list. A table 601 illustrated in FIG. 6 illustrates an example of a list of print functions supported by the extension application 204. The list of print functions supported by the extension application 204 is sometimes updated by the update of the extension application 204.

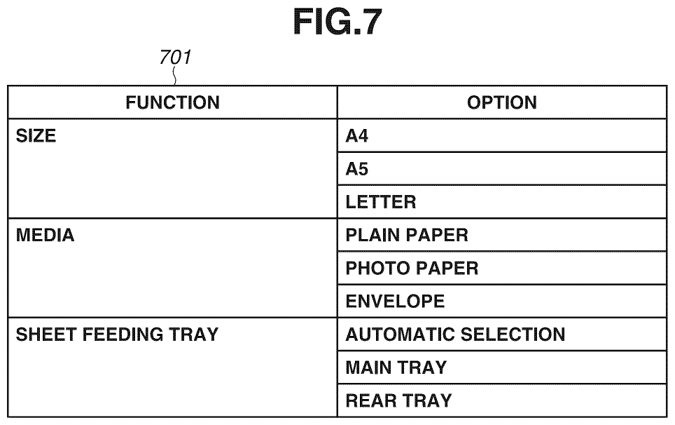

Next, in step S403, the CPU 111 executes the print function extension unit 206, and acquires the PDC 203 created by the general-purpose printing software 202, from the OS. The PDC 203 is created by the general-purpose printing software 202 based on capability information (table 501) acquired by the general-purpose printing software 202 from the printing apparatus 102. Only print functions supported by the general-purpose printing software 202 from among functions included in the capability information acquired from the printing apparatus 102 are described in the PDC 203 created by the general-purpose printing software 202, and therefore functions in the PDC 203 are restrictive. A table 701 illustrated in FIG. 7 illustrates an example of a list of print functions supported by the general-purpose printing software 202. For example, the capability information (table 501) acquired from the printing apparatus 102 includes 7×10 inches and western style No. 6 as sizes, but the general-purpose printing software 202 does not support these sizes, and these sizes are not described in the PDC. The blank sheet saving function is also unsupported, and thus the blank sheet saving function is not described in the PDC. By the print function extension unit 206 adding a function or an option to the PDC, the extension application 204 can complement supplement function deficiency of the general-purpose printing software 202. The print function extension unit 206 can also delete an unnecessary function or option from PDC created by the general-purpose printing software 202.

Subsequent processing in steps S404, S405, and S406 is processing to be repeatedly performed for a function list included in capability information acquired from the printing apparatus 102 in step S401. In the present exemplary embodiment, the processing is processing to be repeatedly performed for 11 types of options from “size: A4” to “blank sheet saving: disable” that are included in the table 501.

In step S404, the CPU 111 executes the print function extension unit 206, and determines whether a function/option being processed is included in PDC generated by the general-purpose printing software 202. If the function/option being processed is included (YES in step S404), the CPU 111 selects the next item in the functions/options included in the capability information from the printing apparatus 102, and performs the processing in step S404 again. If the last item of the functions/options included in the capability information from the printing apparatus 102 is being processed, the CPU 111 ends the processing in the flowchart in FIG. 4. If the function/option being processed is not included (NO in step S404), the processing proceeds to step S405. In the present exemplary embodiment, for example, the “size: A4” indicated in the table 501 indicating capability information of the printing apparatus 102 is also included in the table 701 indicating capability information of the general-purpose printing software 202, it is thus determined that the function/option being processed is included (YES in step S404). In contrast, the “blank sheet saving: enable” indicated in the table 501 is not included in the table 701, it is thus determined that the function/option being processed is not included (NO in step S404), and the processing proceeds to step S405.

In step S405, the CPU 111 executes the print function extension unit 206, and determines whether a function/option being processed is included in functions/options supported by the extension application 204. If a function/option being processed is included (YES in step S405), the processing proceeds to step S406. If a function/option being processed is not included (NO in step S405), the CPU 111 performs the processing in step S404 again similarly to the case where it is determined that the function/option being processed is included (YES in step S404), or ends the processing in the flowchart in FIG. 4. In the present exemplary embodiment, for example, in a case where a function being processed is “blank sheet saving: enable”, the function is included also in the table 601 indicating capability information of the extension application 204, it is thus determined that the function/option being processed is included (YES in step S404), and the processing proceeds to step S406.

In step S406, the CPU 111 executes the print function extension unit 206, and adds the function/option being processed, to the PDC 203. After the processing in step S406, the CPU 111 performs the processing in step S404 again similarly to the case where it is determined that the function/option being processed is included (YES in step S404), or ends the processing in the flowchart in FIG. 4.

As described above, the print function extension unit 206 adds, to the PDC 203, a function/option unsupported by the general-purpose printing software 202, supported by the printing apparatus 102, and supported by the extension application 204. Based on PDC edited through the processing, PC is generated. Furthermore, the print setting screen extension unit 205 generates a display screen based on the generated PC, extends a function unsupported by the general-purpose printing software 202, and can thereby display the advanced settings screen illustrated in FIGS. 3C and 3D.

<Sequence of Processing to be Executed after Drawing Application Receives Print Setting>

Next, a sequence of processing to be executed by the drawing application 201, the general-purpose printing software 202, the extension application 204, and the printing apparatus 102 after the drawing application 201 receives a print setting will be described with reference to FIG. 8. Except for the steps of the printing apparatus 102, the processing in each step in FIG. 8 is performed by the CPU 111 controlling the drawing application 201, the general-purpose printing software 202, or the extension application 204. Each step of the printing apparatus 102 in FIG. 8 is performed by a CPU (not illustrated) in the printing apparatus 102.

In step S801, the CPU 111 executes the drawing application 201, causes the print setting screen to be displayed on the display unit 119, and accepts a print setting made by the user. The user can issue a print setting instruction to the drawing application 201 by operating the pointing device 117 and the keyboard 118.

In step S802, the CPU 111 executes the drawing application 201, and displays the print setting screen illustrated in FIG. 3A on the display unit 119.

In step S803, the CPU 111 executes the drawing application 201, and accepts an advanced settings instruction. The user operates the pointing device 117 or the keyboard 118 to select the control 305, so that the user can issue an advanced settings instruction.

In step S804, the CPU 111 executes the drawing application 201, and transmits an advanced settings display request to the general-purpose printing software 202.

In step S805, the CPU 111 executes the general-purpose printing software 202 to transmit an advanced settings display request to the extension application 204. As described above, in the case of the configuration illustrated in FIG. 2A, the general-purpose printing software 202 displays the advanced settings screen illustrated in FIG. 3B.

In step S806, the CPU 111 executes the print setting screen extension unit 205 of the extension application 204 to cause the display unit 119 to display the advanced settings screen in FIG. 3C. As described with reference to FIG. 4, the blank sheet saving setting is added by the print function extension unit 206 to PDC. Referring to PC generated based on the PDC to which the blank sheet saving setting is added, the print setting screen extension unit 205 displays the advanced settings screen illustrated in FIG. 3C.

In step S807, the CPU 111 executes the print setting screen extension unit 205 of the extension application 204, and accepts advanced settings. In the present exemplary embodiment, as illustrated in FIG. 3C, the CPU 111 accepts settings including “sheet type: plain paper”, “sheet size: A4”, “sheet feeding tray: automatic”, and “blank sheet saving: enable”, from the user.

In step S808, the CPU 111 executes the print setting screen extension unit 205, and accepts an advanced settings end. By operating the pointing device 117 and the keyboard 118, and selecting the control 309, the user can issue an advanced settings end instruction.

In step S809, the CPU 111 executes the extension application 204, and transmits the advanced settings end to the general-purpose printing software 202.

In step S810, the CPU 111 executes the general-purpose printing software 202, and transmits the advanced settings end to the drawing application 201.

In step S811, the CPU 111 executes the drawing application 201, and accepts a print instruction. By operating the pointing device 117 and the keyboard 118, and selecting the control 303, the user can issue a print instruction.

In step S812, the CPU 111 executes the drawing application 201, and issues a print instruction.

In step S813, the CPU 111 executes the general-purpose printing software 202, and causes a module of the OS to generate intermediate data.

In step S814, the CPU 111 executes the general-purpose printing software 202, and stores a PT into the shared information 208.

In step S815, the CPU 111 executes the general-purpose printing software 202, and transmits drawing data in intermediate data to the extension application 204.

In step S816, the CPU 111 executes the intermediate data editing unit 207 of the extension application 204, and acquires the PT stored in step S814, from the shared information 208.

In step S817, the CPU 111 executes the intermediate data editing unit 207 of the extension application 204, and generates print data with reference to intermediate drawing data and the PT.

In step S818, the CPU 111 executes the intermediate data editing unit 207 of the extension application 204, and transmits print data to the printing apparatus 102.

In step S819, the printing apparatus 102 receives and interprets the print data, and executes image processing to be used for an image in the print data. In the present exemplary embodiment, in a case where the print setting illustrated in FIG. 3C is made, blank sheet saving processing is performed.

In step S820, the printing apparatus 102 prints image data generated in step S819. The blank sheet saving processing is performed in step S819, and thus the image data is printed with a blank page being deleted.

As described above, in the present exemplary embodiment, the print setting screen extension unit 205 of the extension application 204 corrects the PDC 203 based on the general-purpose printing software 202, the extension application 204, and capability information of the printing apparatus 102. When a display request of the advanced settings screen is issued by the user, it is possible to make the user to make the blank sheet saving setting by displaying a setting screen based on PC generated from the PDC 203. Moreover, the intermediate data editing unit 207 generates print data based on the set blank sheet saving setting, it is thus possible to reflect the blank sheet saving setting in the print data. Thereafter, the intermediate data editing unit 207 and the printing apparatus 102 receives the print data in which the blank sheet saving setting is reflected, a blank sheet saving module in the printing apparatus 102 performs blank sheet saving processing on image data based on the blank sheet saving setting. Through the above-described series of processes, it is possible to implement the blank sheet saving function in the printing apparatus 102, and it becomes possible to provide the user with the blank sheet saving function.

In the present exemplary embodiment, the description has been given using the advanced settings screen illustrated in FIG. 3C that is to be displayed under the configuration illustrated in FIG. 2B, but the present disclosure is not limited to this. For example, in a case where an advanced settings display request is transmitted to the general-purpose printing software 202 in step S804, the general-purpose printing software 202 may display the advanced settings screen illustrated in FIG. 3E. Subsequently, after the advanced settings end in FIG. 3E, the general-purpose printing software 202 transmits a display request of an additional advanced settings screen to the extension application 204. Next, the extension application 204 may additionally display an advanced settings screen on which the blank sheet saving setting can be made.

In the present exemplary embodiment, the extension application 204 generates print data based on intermediate data generated by the general-purpose printing software 202. Nevertheless, the extension application 204 itself may generate intermediate data.

Hereinafter, a second exemplary embodiment of the present disclosure will be described. In the above-described first exemplary embodiment, the extension application 204 initially generates print data including the blank sheet saving setting, and transmits the print data to the printing apparatus 102. The printing apparatus 102 then interprets the print data including the blank sheet saving setting, and executes blank sheet saving processing with the blank sheet saving module in the printing apparatus 102.

Nevertheless, some printing apparatuses do not include a blank sheet saving module for cost reduction. In such a case, even if an extension application generates print data including the blank sheet saving setting, the printing apparatuses cannot execute the blank sheet saving processing.

For this reason, in a case where a printing apparatus does not include a blank sheet saving module, it is desirable that print data is generated based on images having been subjected to the blank sheet saving processing, and the print data is delivered to the printing apparatus.

In view of the foregoing, it is firstly determined, based on capability information of a printing apparatus, whether the blank sheet saving module is included, according to the second exemplary embodiment. If the printing apparatus includes the blank sheet saving module, print data in which the blank sheet saving setting is then reflected is generated and delivered to the printing apparatus. In contrast, in a case where a printing apparatus does not include the blank sheet saving module, an extension application executes the blank sheet saving processing based on images in drawing data. Subsequently, print data is generated using images having been subjected to the blank sheet saving processing, and the print data is delivered to the printing apparatus. With this configuration, it becomes possible to provide the user with the blank sheet saving function even in a case where a printing apparatus does not include a blank sheet saving module.

Hereinafter, only a difference from the first exemplary embodiment will be described. The second exemplary embodiment and the first exemplary embodiment are different in the following three points: the configuration of a printing system in a case where an extension application is associated, a PDC edit flow, and a sequence of processing to be performed after a drawing application receives a print setting.

### Configuration of Printing System Centered on Software According to Second Exemplary Embodiment (in Case where Extension Application is Associated)

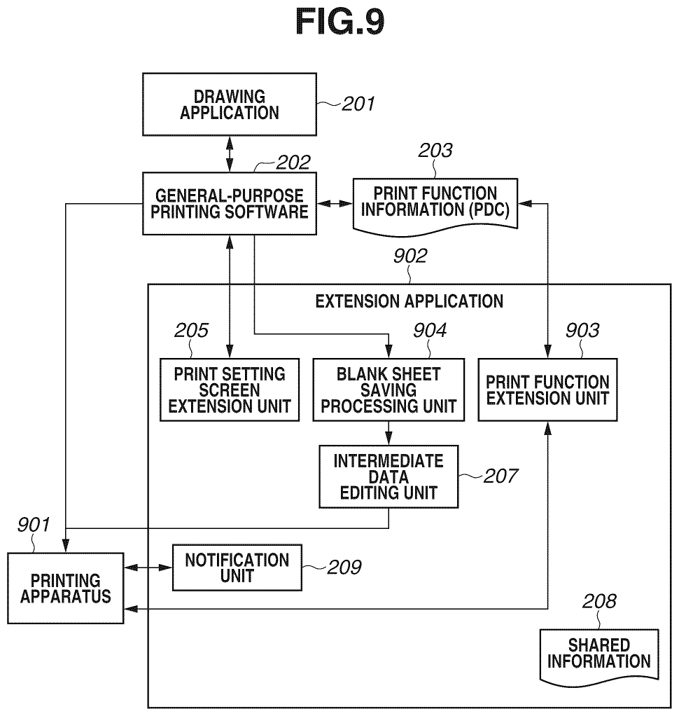

The configuration of the printing system in a case where the extension application 902 is associated will be described with reference to FIG. 9. In FIG. 9, the blocks with the same reference numerals as those in FIG. 2 are the same as those in the first exemplary embodiment, and therefore the description will be omitted. In FIG. 9, blocks different from those in FIG. 2 are four blocks corresponding to a printing apparatus 901, the extension application 902, a print function extension unit 903, and a blank sheet saving processing unit 904. Unlike the printing apparatus 102 according to the first exemplary embodiment, the printing apparatus 901 according to the second exemplary embodiment is a printing apparatus not including a blank sheet saving module. The extension application 902 has a configuration different from that of the extension application 204 according to the first exemplary embodiment. Unlike the print function extension unit 206 according to the first exemplary embodiment, the print function extension unit 903 adds the blank sheet saving function to the PDC 203 if the extension application 204 includes a unit that performs blank sheet saving processing, even in a case where the blank sheet saving function is not included in capability information acquired from a printing apparatus. The blank sheet saving processing unit 904 performs the blank sheet saving processing on images in intermediate data (drawing data) received from the general-purpose printing software 202, based on the blank sheet saving setting made by the user.

The details will be described below.

### Flowchart of Print Function Extension Unit that Edits PDC According to Second Exemplary Embodiment

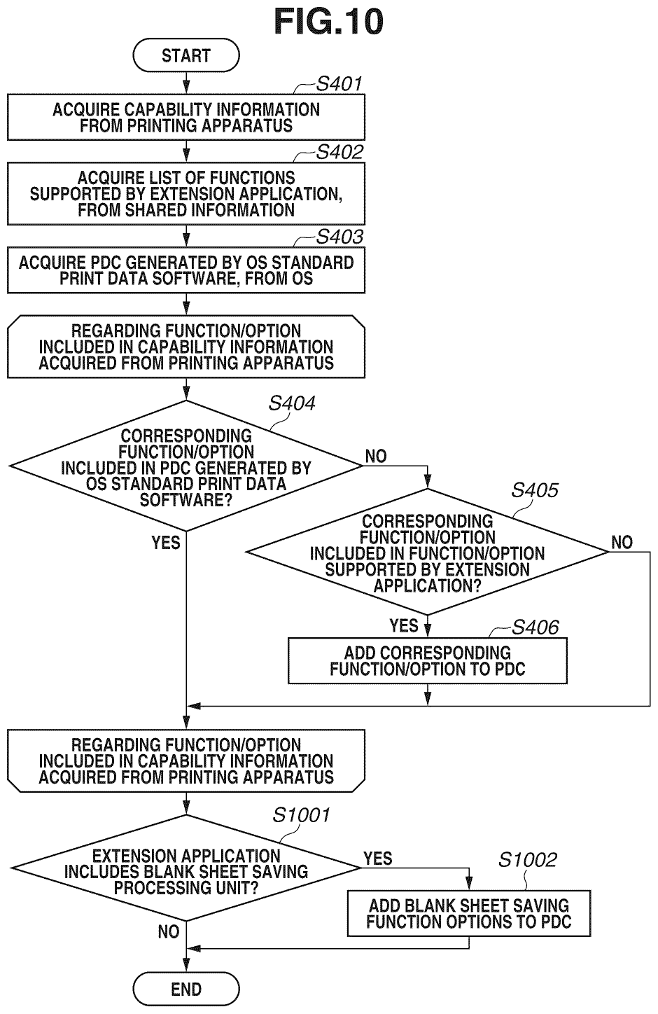

PDC edit processing to be executed by the print function extension unit 903 according to the second exemplary embodiment will be described with reference to FIG. 10. The processing in each step of FIG. 10 is implemented by the CPU 111 executing the print function extension unit 903 of the extension application 902. Processing steps having the same numerals in FIGS. 4 and 10 have the same processing, and thus the description will be omitted.

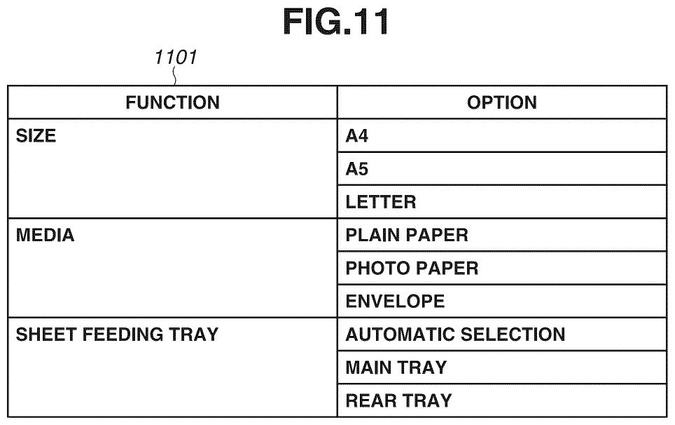

After the repetitive processing in steps S404 to S406 ends, the CPU 111 advances the processing to step S1001. Here, a table 1101 in FIG. 11 indicates capability information to be returned from the printing apparatus 901 in the second exemplary embodiment. Unlike the table 501, the printing apparatus 901 according to the second exemplary embodiment does not include the blank sheet saving module. Thus, the blank sheet saving function is not added to the PDC 203 to be generated after the end of the processing in steps S404 to S406.

In step S1001, the CPU 111 executes the print function extension unit 903, and determines whether the extension application 204 includes a module that performs blank sheet saving processing. If it is determined that the extension application 204 includes the module (YES in step S1001), the processing proceeds to step S1002. If it is determined that the extension application 204 does not include the module (NO in step S1001), the CPU 111 ends the processing illustrated in FIG. 10. Since the extension application 204 according to the second exemplary embodiment includes the blank sheet saving processing unit 904 (YES in step S1001), the processing proceeds to step S1002.

In step S1002, the CPU 111 executes the print function extension unit 903, and adds options of “blank sheet saving: enable/disable” in the table 601 to PDC. As described above, the print function extension unit 903 initially adds, to the PDC 203, a function/option, which is unsupported by the general-purpose printing software 202, supported by the printing apparatus 901, and supported by the extension application 204. Thereafter, the CPU 111 determines whether the extension application 204 includes a blank sheet saving processing unit, and if the extension application 204 includes a blank sheet saving processing unit, the CPU 111 adds the blank sheet saving function to the PDC. Through the processing, the print setting screen extension unit 205 can display the advanced settings screen illustrated in FIG. 3C by generating a display screen based on PC generated from the PDC even in a case where the printing apparatus 901 does not include a blank sheet saving module.

### Sequence of Processing to be Executed after Drawing Application According to Second Exemplary Embodiment Receives Print Setting

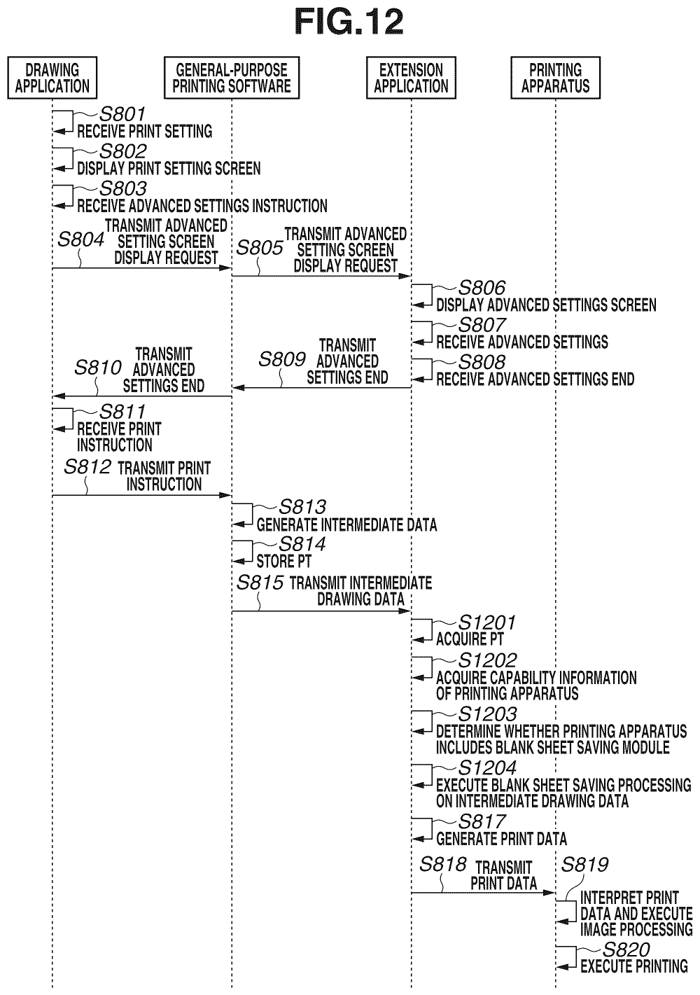

Next, a sequence of processing to be executed by the drawing application 201, the general-purpose printing software 202, the extension application 902, and the printing apparatus 901 after the drawing application 201 receives a print setting will be described with reference to FIG. 12. Except for the steps of the printing apparatus 901, the processing in each step in FIG. 12 is performed by the CPU 111 controlling the drawing application 201, the general-purpose printing software 202, or the extension application 902. Each step of the printing apparatus 901 in FIG. 12 is performed by a CPU (not illustrated) in the printing apparatus 901. Processing steps having the same numerals in FIGS. 12 and 8 have the same processing, and thus the description will be omitted.

In step S1201, the CPU 111 executes the blank sheet saving processing unit 904 of the extension application 902, acquires a PT, and acquires a blank sheet saving setting. In a case where “blank sheet saving: disable” is set, the blank sheet saving processing is not executed, and thus the subsequent processing in steps S1202 to S1204 is skipped.

In step S1202, the CPU 111 executes the blank sheet saving processing unit 904 of the extension application 902, and acquires capability information of the printing apparatus 901 from the shared information 208. If the capability information of the printing apparatus 901 is not acquired, the print function extension unit 903 may transmit a request for capability information to the printing apparatus 901 and store capability information into the shared information 208.

In step S1203, the CPU 111 executes the blank sheet saving processing unit 904 of the extension application 902, and determines whether the printing apparatus 901 includes a blank sheet saving module, based on the capability information acquired in step S1202. In the second exemplary embodiment, because the printing apparatus 901 does not include a blank sheet saving module, it is determined that the printing apparatus 901 does not include a blank sheet saving module (NO in step S1203). In a case where it is determined that the printing apparatus 901 includes a blank sheet saving module (YES in step S1203), the subsequent processing in step S1204 is skipped, and print data is generated. This is because a blank sheet saving module in the printing apparatus 901 can basically perform the blank sheet saving processing at higher speed than the blank sheet saving processing unit 904.

In step S1204, the CPU 111 executes the blank sheet saving processing unit 904 of the extension application 902, performs the blank sheet saving processing on intermediate drawing data based on the blank sheet saving setting acquired in step S1201, and stores the resultant data into the shared information 208. The CPU 111 also edits the blank sheet saving setting in the PT to “disable”. Alternatively, the CPU 111 deletes the blank sheet saving setting from the PT.

As described above, in the first exemplary embodiment, the intermediate data editing unit 207 generates print data in which the blank sheet saving setting is reflected and transmits the print data to the printing apparatus 102, and thereby it is possible to provide the user with the blank sheet saving function. In the second exemplary embodiment, the blank sheet saving processing unit 904 firstly determines whether the printing apparatus 901 includes a blank sheet saving module. In a case where the printing apparatus 901 does not include a blank sheet saving module, the blank sheet saving processing unit 904 executes blank sheet saving processing on intermediate data. In contrast, if the printing apparatus 901 includes a blank sheet saving module, the blank sheet saving processing unit 904 does not execute the blank sheet saving processing. As in the first exemplary embodiment, the intermediate data editing unit 207 generates print data in which the blank sheet saving setting is reflected, and transmits the print data to the printing apparatus 901. In this manner, in the second exemplary embodiment, it becomes possible to provide the user with the blank sheet saving function even in a case where a printing apparatus does not include a blank sheet saving module.

Hereinafter, a third exemplary embodiment of the present disclosure will be described. In the first exemplary embodiment, a case where the printing apparatus 102 performs blank sheet saving has been described, and in the second exemplary embodiment, a case where the extension application 902 performs blank sheet saving has been described.

The blank sheet saving processing according to the first and second exemplary embodiments determines whether a corresponding page is a blank page, based on whether a drawing command is included, as described above. Nevertheless, while this method can execute blank sheet saving through simple processing, a page desired by the user to be deleted as a blank page sometimes fails to be deleted. As an example of such cases, there is a case where a blank page on which show-through occurs exists. The show-through is a phenomenon in which an image printed on one side is seen on the other side through paper in a read image of a printed material read by a reading device such as a scanner. For example, in a case where a simplex-printed material having a front side on which an image is printed, and a blank back side is subjected to duplex reading, the image printed on the front side is read with being seen on a blank portion of the back side through paper, and image data on the back side becomes a faintly-appearing image obtained by inverting the image printed on the front side, instead of being blank. In recent years, there has been an increase in the use of reading devices such as scanners to store a printed material as Portable Document Format (PDF) data, and there has also been an increase in the re-printing of a digitalized printed material. In a case where duplex reading is set when a printed material is read, and in a case where a printed material having a printed image only on a front side is read, the back side is originally blank and thus read data of the back side is to become a blank page. However, in a case where the show-through occurs, an object exists in the read data of the back side. In the case of printing the read data of the back side, a drawing command is added to print data, and thus the page is not deleted as a blank page even if the blank sheet saving function is executed. In order to delete even a page on which show-through occurs, as a blank page, image analysis may be performed instead of the determination of a drawing command. In other words, it may be determined whether a corresponding page is a blank page, by analyzing information regarding a rendered bitmap image for each pixel. Hereinafter, blank sheet saving processing for determining a blank page based on a drawing command will be referred to as a blank sheet saving mode 1, and blank sheet saving processing for determining a blank page by performing image analysis will be referred to as a blank sheet saving mode 2.

In the case of the blank sheet saving mode 2, however, image analysis is performed for each pixel, a processing amount is large, and thereby a processing time increases unless a dedicated processing module is provided. For this reason, in a case where the printing apparatus 901 includes a dedicated module that processes the blank sheet saving mode 2, it is desirable to execute the processing in the printing apparatus 901. Even in a case where the printing apparatus 901 includes a dedicated module that processes the blank sheet saving mode 2, a processing time becomes shorter when the processing is executed in the blank sheet saving mode 1 in a case where a blank page can be determined in the blank sheet saving mode 1 (e.g., blank page on which show-through does not occur). If the capacity of print data can be reduced by deleting a blank page that can be deleted in the blank sheet saving mode 1 before print data is transmitted to the printing apparatus 901, a data transmission time to the printing apparatus 901 can also be shortened. For this reason, it is desirable that the processing in the blank sheet saving mode 1 is performed by the blank sheet saving processing unit 904 of the extension application 902, and the processing in the blank sheet saving mode 2 is performed by the dedicated module of the printing apparatus 901, in consideration of a time from when the user issues a print instruction to when printing is executed.

In the third exemplary embodiment, the details of the processing in the blank sheet saving mode 2, and a method of executing the blank sheet saving mode 1 by the extension application 902, and the blank sheet saving mode 2 by the printing apparatus 901 will be described.

Hereinafter, only a difference from the first and second exemplary embodiments will be described.

### Processing Example of Blank Sheet Saving Mode 2

Here, a processing example of the blank sheet saving mode 2 will be described.

As described above, image analysis is performed in the blank sheet saving mode 2, and thus the processing starts from the reception of image data such as a rendered bitmap image. The blank page determination in the blank sheet saving mode 2 is performed based on a result obtained by combining results of broadly divided two pieces of processing. The two pieces of processing includes processing of determining a blank page based on histogram information of a received image, and processing of determining a blank page based on edge information of a received image. Final blank page determination is made based on the combined result of both processing results. It can be determined that a corresponding page is not a blank page by detecting a histogram distribution different from the color of base paper, from histogram information. However, in a case where an image with a color close to the color of base paper exists, it cannot be determined that a corresponding page is not a blank page, only by a histogram. Thus, by performing determination that uses edge information, an image with a color close to the color of base paper can also be determined. For this reason, final determination is made based on the combined result of the two processing results.

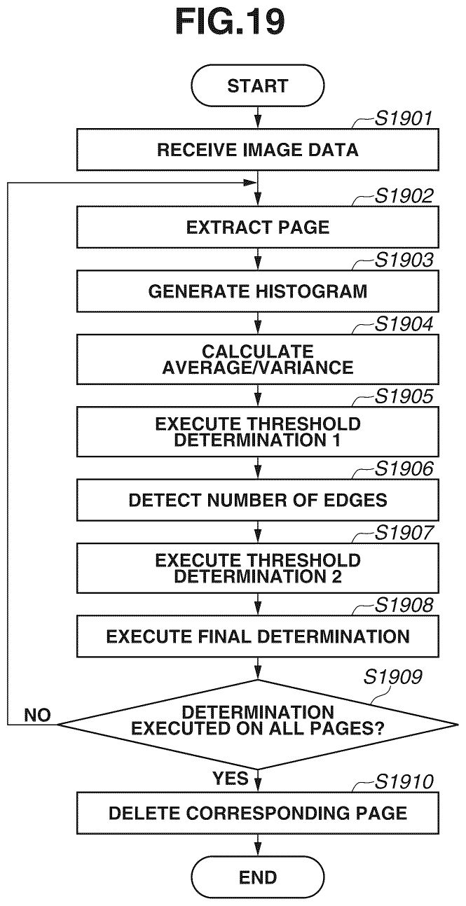

FIG. 19 illustrates a processing flow to be performed by the printing apparatus 901 from image data reception to blank page deletion in a case where the blank sheet saving mode 2 is enabled. All the processes in FIG. 19 are performed by the printing apparatus 901. In the present exemplary embodiment, the CPU 2001 (not illustrated) of the printing apparatus 901 loads a program stored in the ROM 2002 into the RAM 2003 and executes the program, thereby executing a function of the printing apparatus 901 and processing according to a flowchart to be described below.

In step S1901, the CPU 2001 receives image data. In the present exemplary embodiment, the description will be given assuming that a rendered bitmap image is received as an example. However, image data to be received may not be a bitmap image as long as the image is in a raster image state and in a format manageable by the printing apparatus 901.

In step S1902, the CPU 2001 extracts data corresponding to one page, from the image data received in step S1901.

In step S1903, the CPU 2001 generates a histogram from the image data corresponding to one page that has been extracted in step S1902. In the present exemplary embodiment, the description will be given assuming that image data is an RGB (red, green, blue) 8-bit image, but the image data is not limited to this. The histogram represents the number of pixels that have the same signal value. In the present exemplary embodiment, the histogram represents the number of pixels that have the same signal value for each of 3ch R, G, and B signal values. An R, G, or B signal value is extracted from image data for one pixel. If the extracted R, G, or B signal value of the pixel is a first-time value, “1” is recorded in association with the signal value, and when the same R, G, or B signal value is extracted, 1 is added to the recorded value. The number of pixels that have the same signal value can thereby be represented for each of R, G, and B. The histogram generation method is not limited to this method. It is sufficient that the number of pixels that have the same signal value is counted.

In step S1904, the CPU 2001 calculates an average value and a variance value from the histogram generated in step S1903. The average value is obtained by the following formula 1.

$$Sum\_r = \sum ( Pr \times Ht ( Pr ) ) , \qquad Formula 1$$

$$Average\_r = Sum\_r / Ht\_all \_r ,$$

$$Sum\_g = \sum ( Pg \times Ht ( Pg ) ) ,$$

$$Average\_g = Sum\_g / Ht\_all \_g ,$$

$$Sum\_b = \sum ( Pb \times Ht ( Pb ) ) ,$$

$$Average\_b = Sum\_b / Ht\_all \_b ,$$

where a Sum denotes a total value of signal values of all pixels of R, G, and B, Pr denotes a signal value from 0 to 255, Ht denotes a histogram value with respect to each signal value, Ht_all denotes the number of all pixels, and Average denotes an average value.

The variance value is obtained by the following formula 2.

$$Vari\_r = \sum ( ( Average\_r - Pr ) \hat{} 2 \times Ht ( Pr ) ) / Ht\_all \_r , \qquad Formula 2$$

$$Vari\_g = \sum ( ( Average\_g - Pg ) \hat{} 2 \times Ht ( Pg ) ) / Ht\_all \_g ,$$

$$Vari\_b = \sum ( ( Average\_b - Pb ) \hat{} 2 \times Ht ( Pb ) ) / Ht\_all \_b ,$$

where Vari denotes a variance value of each of R, G, and B, and other items denote the same values as those in Formula 1.

In step S1905, the CPU 2001 performs threshold determination 1 using the average value and the variance value calculated in step S1904. The CPU 2001 compares the average value and the variance value calculated in step S1904 using predetermined thresholds stored in a storage device such as a ROM that is included in the printing apparatus 901. In the present exemplary embodiment, the CPU 2001 firstly compares the average value calculated in step S1904 with a threshold for the average value. In a case where the average value is equal to or smaller than the threshold, the CPU 2001 determines that a corresponding page is not a blank page, as threshold determination 1. In a case where the average value is larger than the threshold, the CPU 2001 compares the variance value calculated in step S1904 with a threshold for the variance value. In a case where the variance value is equal to or larger than the threshold, the CPU 2001 determines that a corresponding page is not a blank page, as threshold determination 1, and in a case where the variance value is smaller than the threshold, the CPU 2001 determines that a corresponding page is a blank page, as threshold determination 1. The example in which the processing in steps S1902 to S1905 is performed on the entire surface of the extracted image data corresponding to one page has been described. Alternatively, the image data may be divided into predetermined regions, and the processing in steps S1902 to S1905 may be performed for each divided region.

In step S1906, the CPU 2001 performs processing of detecting the number of edges. First of all, the CPU 2001 enhances edges of an image with a general edge enhancement filter before extracting edges. In the present exemplary embodiment, the CPU 2001 performs the processing for each of R, G, and B channels. The CPU 2001 then compares each of R, G, and B pixel values of the edge-enhanced image with a predetermined threshold prestored in a storage device such as a ROM that is included in the printing apparatus 901, extracts pixels corresponding to edges, and counts the number of pixels.

In step S1907, the CPU 2001 performs threshold determination 2 based on a count value calculated in step S1906. In the threshold determination 2, the CPU 2001 compares a predetermined threshold prestored in a storage device such as an ROM that is included in the printing apparatus 901, and a count value of each of the R, G, and B channels that is calculated in step S1906, and performs blank page determination as the threshold determination 2. When a count value of each of the R, G, and B channels and a threshold are compared, and at least one count value of the count values of the R, G, and B channels is equal to or larger than the threshold, the CPU 2001 determines a corresponding page to be not a blank page, as the threshold determination 2.

In step S1908, the CPU 2001 performs final determination as to whether a corresponding page is a blank page. Only in a case where both determination results of the threshold determination 1 in step S1905 and the threshold determination 2 in step S1907 indicate that the corresponding page is a blank page, the CPU 2001 determines that a page extracted in step S1902 is a blank page. If not, the CPU 2001 determines that a page extracted in step S1902 is not a blank page.

In step S1909, the CPU 2001 determines whether all pages of image data received in step S1901 have been determined. By acquiring the number of pages in image data reception, the CPU 2001 may determine whether the processing has been performed for the number of pages, or by extracting pages until image data runs out, the CPU 2001 may determine that all pages have been determined, if image data runs out. In a case where it is determined that all pages have not been determined (NO in step S1909), the processing returns to step S1902.

In step S1910, the CPU 2001 deletes a page determined to be a blank page in the processing up to step S1909. A corresponding page may be completely erased as image data, or the corresponding page may be deleted at a different timing by applying a flag indicating that the corresponding page is a blank page. In the blank sheet saving mode 2, a blank page determination level can be varied by adjusting each threshold. For example, by increasing the determination level, even more dense show-through can be determined to be a blank page. In contrast, by decreasing the determination level, show-through other than pale show-through can be determined to be not a blank page. In view of the foregoing, a UI that can change a blank page determination level like a slide bar 314 in FIG. 3F may be added, a threshold corresponding to a setting value of the slide bar 314 may be stored, and blank page determination may be made using a threshold corresponding to the set blank page determination level. The slide bar 314 can move toward a minus side and a plus side across 0 at the center, and can vary the blank page determination level. As a matter of course, the slide bar 314 is an example, and may have any shape as long as the blank page determination level can be set.

### Sequence of Processing to be Executed after Drawing Application According to Third Exemplary Embodiment Receives Print Setting

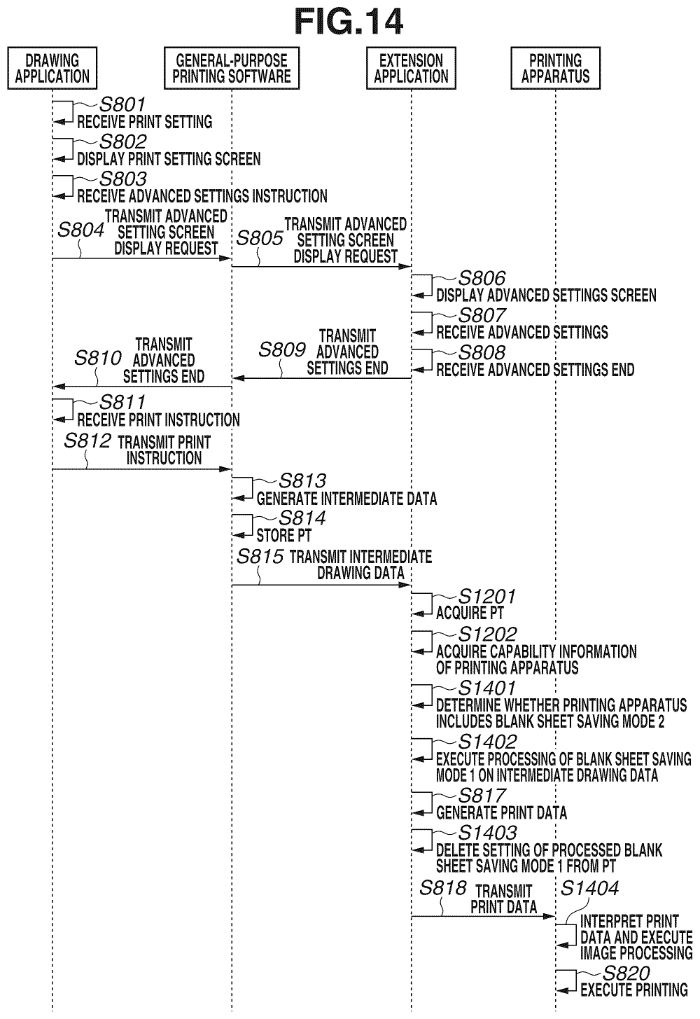

A sequence of processing to be executed by the drawing application 201, the general-purpose printing software 202, the extension application 902, and the printing apparatus 901 after the drawing application 201 receives a print setting will be described with reference to FIG. 14. Except for the steps of the printing apparatus 901, the processing in each step in FIG. 14 is performed by the CPU 111 controlling the drawing application 201, the general-purpose printing software 202, or the extension application 902. Each step of the printing apparatus 901 in FIG. 14 is performed by the CPU 2001 in the printing apparatus 901. Because the same processing is performed in steps of FIG. 14 that have the same step number, the description will be omitted.

In step S1401, the CPU 111 executes the blank sheet saving processing unit 904 of the extension application 902, and determines whether the printing apparatus 901 includes a processing module of the blank sheet saving mode 2, based on capability information acquired in step S1202. In the third exemplary embodiment, the printing apparatus 901 includes the processing module of the blank sheet saving mode 2, it is thus determined that the printing apparatus 901 includes the processing module (YES in step S1401).

In step S1402, the CPU 111 executes the blank sheet saving processing unit 904 of the extension application 902, performs the processing in the blank sheet saving mode 1 on intermediate drawing data, and stores resultant data into the shared information 208. The processing in the blank sheet saving mode 1 is as described in <Processing Example of Blank Sheet Saving Function> in the first exemplary embodiment.

Subsequently, after the generation of print data in step S817, the CPU 111 edits, in step S1403, the setting of the blank sheet saving mode 1 in a PT to “0”. Alternatively, the CPU 111 deletes the setting of the blank sheet saving mode 1 from the PT.

Subsequently, the printing apparatus 901 interprets the print data transmitted in step S818, and executes image processing to be used for an image in the print data. In the present exemplary embodiment, the processing in the blank sheet saving mode 2 is performed as one type of image processing. As described above, the processing described in <Processing Example of Blank Sheet Saving Mode 2> is performed.

In the first and second exemplary embodiments, a method of enabling the blank sheet saving processing to be executed in a case where an extension application is used, in a case where only the blank sheet saving mode 1 is executable has been described. In the present exemplary embodiment, as described above, the blank sheet saving processing that uses the extension application becomes executable, by performing the processing in the blank sheet saving mode 1 for determination that is based on a drawing command with an extension application, and performing the processing in the blank sheet saving mode 2 for determination that is based on image analysis with a printing apparatus, even in a case where there are a plurality of blank sheet saving modes. It is also possible to improve printing performance in a case where there are a plurality of blank sheet saving modes.

In the present exemplary embodiment, the processing in the blank sheet saving mode 1 is executed by the extension application, and the processing in the blank sheet saving mode 2 is executed by the printing apparatus. This is a flow in which importance is given to printing performance. For this reason, in the case of giving importance to another purpose, the configuration is not limited thereto. A module that executes processing may be switched by executing processing in each mode only by the extension application, or only by the printing apparatus. For example, in the case of displaying a preview to be described below, it is desirable to execute the processing in both the modes 1 and 2 by the extension application. If communication between a host computer and a printing apparatus is performed at high speed, the processing in both of the modes 1 and 2 may be executed by the printing apparatus.

Hereinafter, a fourth exemplary embodiment of the present disclosure will be described. In the first to third exemplary embodiments, a page determined to be a blank page is automatically deleted (or processing equivalent to deletion is executed thereon). Nevertheless, in a case where the total number of pages is desired to remain unchanged, or in a case where a page number should not vary in booklet printing or the like, even if a page is determined to be a blank page, some users desire not to delete the page. Thus, in the fourth exemplary embodiment, a method in which the extension application 902 displays a preview of a blank sheet saving result before printing, and a page to be deleted can be selected will be described.

Hereinafter, only a difference from the first, second, and third exemplary embodiments will be described.

### Sequence of Processing to be Executed after Drawing Application According to Fourth Exemplary Embodiment Receives Print Setting

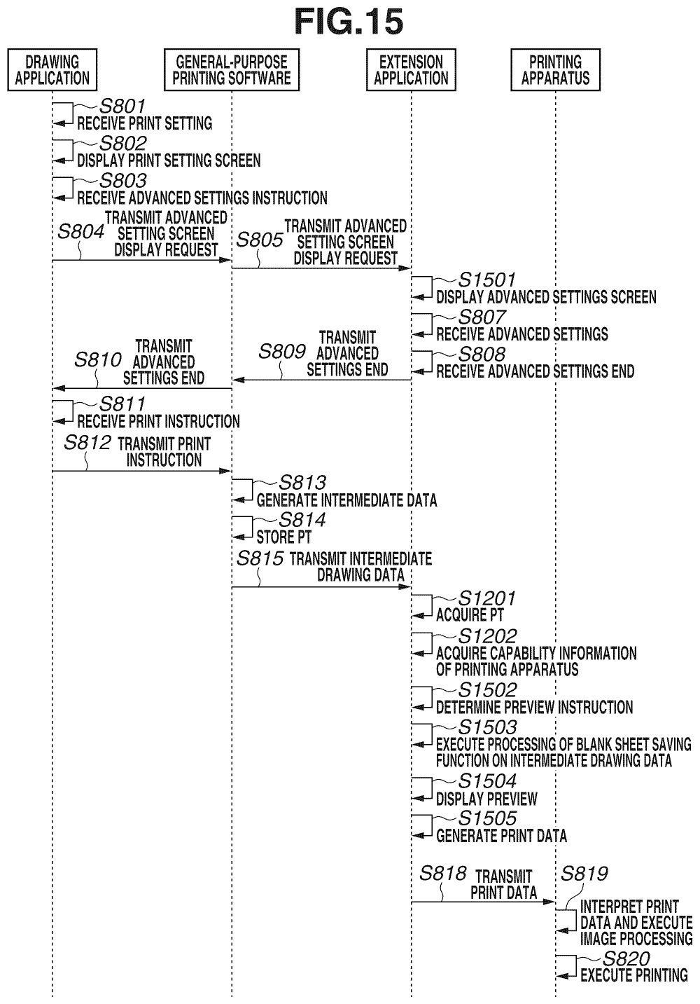

A sequence of processing to be executed by the drawing application 201, the general-purpose printing software 202, the extension application 902, and the printing apparatus 901 after the drawing application 201 receives a print setting will be described with reference to FIG. 15. Except for the steps of the printing apparatus 901, the processing in each step in FIG. 15 is performed by the CPU 111 controlling the drawing application 201, the general-purpose printing software 202, or the extension application 902. Each step of the printing apparatus 901 in FIG. 15 is implemented by the CPU 2001 of the printing apparatus 901 loading a program stored in the ROM 2002, onto the RAM 2003 and executing the program. The same processing is performed in steps of FIG. 15 that have the same step number, and thus the description will be omitted.

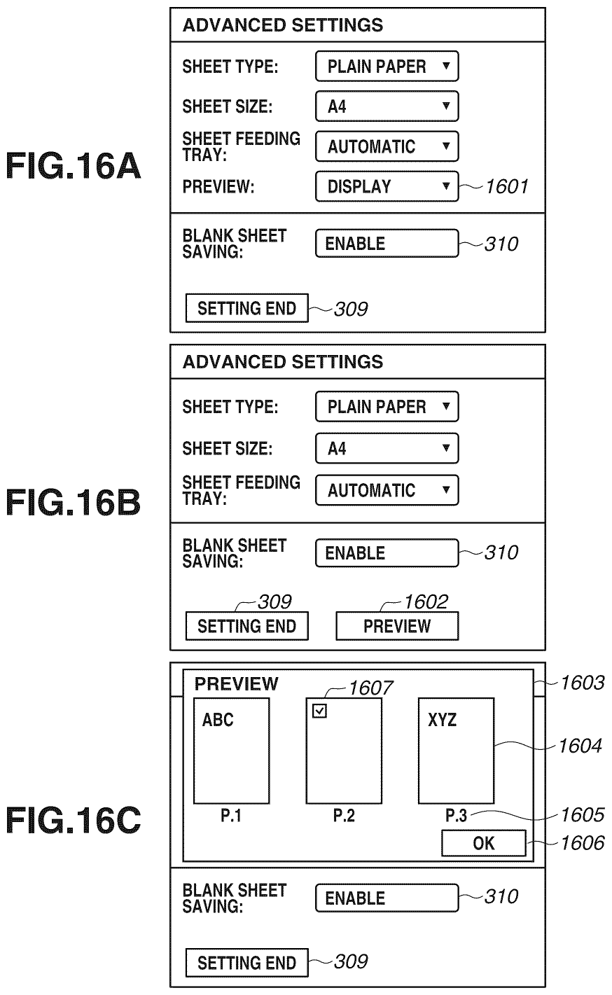

In step S1501, the CPU 111 executes the print setting screen extension unit 205 of the extension application 902, and displays an advanced settings screen illustrated in FIG. 16A. The advanced settings screen according to the fourth exemplary embodiment is obtained by adding a control 1601 for selecting whether to display a preview, to the advanced settings screen illustrated in FIG. 3C. Because the subsequent processing up to step S1202 is similar to that in the first, second, and third exemplary embodiments, the description will be omitted.

In step S1502, the CPU 111 executes the print setting screen extension unit 205 of the extension application 902, and determines whether “display” a preview is set in the control 1601 illustrated in FIG. 16A.

In a case where “display” a preview is set in the control 1601 illustrated in FIG. 16A, the CPU 111 executes, in step S1503, the blank sheet saving processing unit 904 of the extension application 902, and executes blank sheet saving processing on intermediate drawing data. In a case where the blank sheet saving function has a mode as in the third exemplary embodiment, all the processes are performed by the extension application 902.

Regarding the blank sheet saving mode 2, a module that executes the processing merely changes from the printing apparatus 901 to the extension application 902, and the processing to be executes is the same as <Processing Example of Blank Sheet Saving Mode 2> in the third exemplary embodiment.

In step S1504, the CPU 111 executes the print setting screen extension unit 205 of the extension application 902, and displays intermediate drawing data obtained after the blank sheet saving processing, as illustrated as a preview 1603 in FIG. 16C. The CPU 111 displays intermediate drawing data for each page like a preview image 1604.

In a case where all pages cannot be displayed at a time, a page to be displayed may be made selectable by adding a page scroll function, or adding a scroll bar for scrolling the screen. A displayed page may be made easy-to-understand by showing a page number of the displayed page, like a page number 1605. A checkbox 1607 is displayed for a page determined to be a blank page, as a result of the blank sheet saving processing. By selecting or deselecting the checkbox 1607, whether to delete the corresponding page is switched. In the present exemplary embodiment, the corresponding page is deleted, for example, in a case where a checkbox is selected. The method of switching whether to delete a corresponding page is not limited to the method of using the checkbox, and may be any method as long as a page determined to be a blank page is recognizable, and whether to delete a corresponding page can be switched. If an OK button 1606 is pressed, the screen returns to the original advanced settings screen. In a case where the screen returns to the advanced settings screen, “display” a preview in the control 1601 is deselected, and then a setting end button of the control 309 is pressed, the processing in step S1505 and subsequent steps is executed.

In step S1505, the CPU 111 generates print data using the intermediate drawing data and a PT. At this time, in a case where there is a blank page and a deletion instruction is issued in step S1504 (state in which the checkbox 1607 is selected in FIG. 16C), the CPU 111 does not generate print data of a corresponding page. In addition, in a case where information regarding a page, such as the total number of pages, is recorded in print data, the information is rewritten in the processing.

In a case where “display” a preview is not set, similarly to the first, second, and third exemplary embodiments, the blank sheet saving processing is performed by either one or both of the blank sheet saving processing unit 904 and the printing apparatus 901 of the extension application 902 in accordance with capability information.

In the fourth exemplary embodiment, a configuration of displaying a preview as another screen has been described, but the preview may be included in the advanced settings screen. The preview may be displayed in any format as long as the preview can be displayed. In the fourth exemplary embodiment, the display of a preview is switched using the control 1601. Alternatively, a preview button 1602 may be displayed as illustrated in FIG. 16B, and the processing in steps S807 to S1504 may be executed at the time point when the preview button 1602 is pressed.

In the first to third exemplary embodiments, a page determined to be a blank page is automatically deleted.

In the fourth exemplary embodiment, as described above, an extension application executes the blank sheet saving processing, and an execution result is displayed as a preview. With this configuration, the extension application 902 can display a preview of intermediate drawing data obtained after blank sheet saving, and blank page determination result check and the selection of a page to be deleted can be performed before printing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU), or the like) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), Blu-ray Disc (BD)™, or the like), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-005271, filed Jan. 17, 2024, which is hereby incorporated by reference herein in its entirety.

What is claimed is:

1. A computer-readable storage medium storing a program for supporting general-purpose printing software which is able to be used in common by image forming apparatuses of a plurality of manufacturers,
wherein, when the program is executed, a processor causes an information processing apparatus to:
display a screen for receiving a setting of blank sheet saving; and
perform control, based on the setting of blank sheet saving that has been received on the screen, such that a page having no image data among data generated by the general-purpose printing software is not printed.

2. The storage medium according to claim 1, wherein, based on the setting for blank sheet saving that has been received on the screen, the processor causes the information processing apparatus to remove a page having no image data from among data generated by the general-purpose printing software.

3. The storage medium according to claim 2, the processor further causing the information processing apparatus to:
acquire capability information from an image forming apparatus; and
determine, based on the capability information, whether the image forming apparatus has a function of removing a page having no image data.

4. The storage medium according to claim 3, wherein, in a case where it is determined that the image forming apparatus does not have the function of removing the page having no image data, and in a case where the program has the function of removing the page not including image data, the processor enables the information processing apparatus to receive the setting of blank sheet saving.

5. The storage medium according to claim 1, the processor further causing the information processing apparatus to:
display a preview on a display unit based on data generated by the general-purpose printing software.

6. The storage medium according to claim 5, the processor further causing the information processing apparatus to:
display, on the display unit, information indicating whether a page included in data displayed as the preview is a blank page.

7. The storage medium according to claim 6, the processor further causing the information processing apparatus to:
display, on the display unit, a screen for selecting whether to delete the image determined to be the blank page.

8. The storage medium according to claim 1, the processor further causing an information processing apparatus to:
receive selection of one blank sheet saving method from among a plurality of blank sheet saving methods including a first blank sheet saving method of performing blank sheet saving using a first method, and a second blank sheet saving method of performing blank sheet saving using a second method.

9. The storage medium according to claim 1, wherein the general-purpose printing software is an internet printing protocol (IPP) class driver.

10. A control method of an information processing apparatus, the control method comprising:
displaying, by executing a program for supporting general-purpose printing software which is able to be used in common by image forming apparatuses of a plurality of manufacturers, a screen for receiving a setting of blank sheet saving; and
performing control, based on the setting of blank sheet saving that has been received on the screen, such that a page having no image data among data generated by the general-purpose printing software is not printed, by executing the program.

11. An information processing apparatus comprising:
a display unit configured to display a screen for receiving a setting of blank sheet saving, by executing a program for supporting general-purpose printing software which is able to be used in common by image forming apparatuses of a plurality of manufacturers; and
a control unit configured to perform control, based on the setting of blank sheet saving that has been received on the screen, such that a page having no image data among data generated by the general-purpose printing software is not printed, by executing the program.
